(19) United States
(12) Patent Application Publication
(10) Pub. No.: US 2026/0080081 A1
(43) Pub. Date: Mar. 19, 2026

(54) SENSITIVE DATA DETECTION

(71) Applicant: Microsoft Technology Licensing, LLC, Redmond, WA (US)

(72) Inventors: Michael C. Fanning, Redmond, WA (US); Ashok CHANDRASEKARAN, Redmond, WA (US); Ross A. WOLLMAN, San Francisco, CA (US); Ryan Andrew ERDMANN, Redmond, WA (US); Yan SUI, Bellevue, WA (US); Suvam MUKHERJEE, Allston, MA (US); Liye XU, Kirkland, WA (US); Harini A. TRIMMER, Duvall, WA (US)

(21) Appl. No.: 18/889,108

(22) Filed: Sep. 18, 2024

(51) Int. Cl. G06F 21/62

(52) U.S. Cl. CPC G06F 21/6218

(57) ABSTRACT

Some embodiments form a sensitive data identification data structure (SDIDS) which includes an identifiable sensitive data (ISD) portion. Some embodiments scan for an SDIDS, and some do both. The SDIDS is distinguished by at least one of: specified rarity of an adherence signature, absence of a checksum, primary and secondary adherence signatures, non-prefix adherence signature position, non-suffix checksum position, or particular kinds of metadata. Some examples of suitable metadata include timestamp metadata, deployment metadata, origination metadata, ownership metadata, metadata for testing, correlation metadata, and combinations thereof. Some ISD examples include security keys, tokens, passwords, pass phrases, cryptologic artifacts, confidential data, private data, critical data, and data that is tagged or labeled as sensitive.

### BACKGROUND

Attacks on a computing system may take many different forms, including some forms which are difficult to predict, and forms which may vary from one situation to another. Accordingly, one of the guiding principles of cybersecurity is “defense in depth”. In practice, defense in depth is often pursed by identifying and closing security gaps, and by forcing attackers to encounter multiple different kinds of security mechanisms at multiple different locations around or within the computing system. No single security mechanism is able to identify every vulnerability or detect every kind of cyberattack, able to determine the scope of an attack or a vulnerability, able to remove every vulnerability, and able to end every detected cyberattack. But sometimes combining and layering a sufficient number and variety of defenses and investigative tools will prevent an attack, deter an attacker, or at least help limit the scope of harm from an attack or a vulnerability.

To implement defense in depth, cybersecurity professionals consider the different kinds of attacks that could be made against a computing system, and the different vulnerabilities the system may include. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place or removing a particular vulnerability to attack. They investigate the scope of an attack, and try to detect vulnerabilities before they are exploited in an attack. Some defenses or investigations might not be feasible or cost-effective for a particular computing system. However, improvements in cybersecurity remain possible, and worth pursuing.

### SUMMARY

Some embodiments address technical challenges arising in computer usage, both on individual computers and as part of computer network operations. One challenge is how to promptly, efficiently, and effectively identify sensitive data inside large amounts of data such as a data stream, a source code repository, or a key vault. Another challenge is how to promptly, efficiently, and effectively determine that a particular sensitive data item is outside the set of authorized locations for that item. Another challenge is how to promptly, efficiently, and effectively determine the origin of a particular sensitive data item. Another challenge is how to facilitate testing of cybersecurity tools and techniques without risking exposure of actual sensitive data. Other technical challenges are also addressed herein.

Some embodiments taught herein provide or utilize technology which increases the security of computer operations. In some embodiments, cybersecurity software (i) forms a contiguous sensitive data identification data structure (SDIDS) in a computer memory, the SDIDS including at least one of: (a) a predefined primary adherence signature plus a predefined secondary adherence signature in a hierarchy whereby the predefined secondary adherence signature is selected from a plurality of predefined secondary adherence signatures which are each associated with a respective nonempty proper subset of a nonempty set of SDIDS instances, each SDIDS instance having the predefined primary adherence signature, (b) the predefined primary adherence signature having a very low instance frequency within a corpus of digital or having a very low false positive detection rate, or both, or (c) the predefined primary adherence signature being internal to the SDIDS and hence not being a prefix of the SDIDS, (ii) ascertains an identifiable sensitive data (ISD) within the SDIDS, and (iii) utilizes the SDIDS to improve security functioning of the computing system. Suitable values for “very low” are provided herein.

Other technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including some aspects generally suitable for embodiments which include or use SDIDS functionality;

FIG. 2 is a block diagram illustrating aspects of a family of enhanced systems which are each configured with SDIDS functionality;

FIG. 3 is a block diagram illustrating aspects of another family of systems which are each enhanced with SDIDS functionality, including some systems with SDIDS software which upon execution performs a family of SDIDS methods;

FIG. 4 is a block diagram illustrating aspects of SDIDS metadata, including examples of several different kinds of SDIDS metadata;

FIG. 5 is a block diagram illustrating aspects of SDIDS deployment metadata;

FIG. 6 is a block diagram illustrating aspects of SDIDS origination metadata;

FIG. 7 is a block diagram illustrating aspects of SDIDS test metadata;

FIG. 8 is a block diagram illustrating some additional aspects of SDIDS functionality;

FIG. 9 is a flowchart further illustrating the family of SDIDS methods; and

FIG. 10 is a flowchart further illustrating SDIDS methods, and incorporating as options the steps of FIGS. 2, 3, and 9.

### DETAILED DESCRIPTION

### Overview

Some teachings described herein were motivated by technical challenges faced and insights gained during efforts to improve technology for detecting security keys in source code. These challenges and insights provided some motivations, but the teachings herein are not limited in their scope or applicability to these particular tools, motivational challenges, solutions, or insights.

Historically, many security models have minted access keys and other secrets in formats that are difficult to distinguish from other data. Due to resulting high false positive rates during attempts to detect keys or other secrets in source code or other documents, it has not been possible to scale out and left-shift stringent security controls to prevent leaked secrets for these models.

To address this problem, some approaches provide or utilize a “highly identifiable secrets” (HIS) format. The adoption of HIS helps prevent security keys from leaking in source code, by allowing systems such as software development and operation (DevOps) tools to efficiently scan proposed edits and to hard-block introduction of leaked keys. The adoption of HIS also supports scale-out scanning of source code, such as all public open-source software (OSS), where scan-on-save is not yet enabled.

However, merely determining that a piece of data in a document is a security key, for example, leaves many questions unanswered. Depending on the circumstances, relevant unanswered questions include, e.g., where and when that security key originated, what the authorized scope of deployment is for the security key, where other instances of the security key are located, who owns management of the security key, and the path taken by the security key before it became part of the document. A practical impact of such unanswered questions has been undesirable delays in routing mitigation tasks and in performing remediation of security key exposures.

Some embodiments taught herein extend an HIS key format to incorporate security-relevant annotations for governance, and to further improve detection efficiency. Some extend a particular HIS v1 key format by including metadata that enables stronger key governance. The HIS v1 key format defines a per-provider signature (not a primary adherence signature), and utilizes a seeded checksum (a 32-bit computed value) placed at the end of the key. Some embodiments provide or utilize a format that maximizes detection efficiency for secrets redaction and other performance-sensitive scenarios. Some embodiments provide or utilize a specific implementation of a general HIS v2 standard that can be adopted across many clouds and which is tuned for detectability and flexibility. “Standard” herein means that bitfields of a sensitive data identification data structure are defined and offered as a suitable implementation, not that any particular entity or regulation compels compliance with that definition. Also, “HIS v2” refers to some examples of embodiments, but teachings and embodiments herein are not limited to the HIS v2 examples.

Some embodiments described herein utilize or provide a cybersecurity method, which is performed by a computing system, and which includes forming a contiguous sensitive data identification data structure (SDIDS) in the computing system memory, the SDIDS including a predefined primary adherence signature plus a predefined secondary adherence signature in a hierarchy whereby the predefined secondary adherence signature is selected from a plurality of predefined secondary adherence signatures which are each associated with a respective nonempty proper subset of a nonempty set of SDIDS instances, each SDIDS instance having the predefined primary adherence signature, ascertaining an identifiable sensitive data (ISD) within the SDIDS, and utilizing the SDIDS to improve security functioning of the computing system.

This SDIDS functionality has the technical benefit of allowing efficient and effective data scanning to identify a wide variety of security keys, token signatures, secrets, account numbers, or other sensitive data in various formats, in situations where scanning for matches to more than one sensitive data format is prohibitively slow, e.g., too computationally expensive to avoid unacceptable delay in a data stream. Instead of scanning for data that matches dozens or even hundreds of different formats' signatures, tools can scan for the predefined primary adherence signature. If it is not present, scanning continues and the data stream flows on without delay. If the predefined primary adherence signature is found, then subsidiary scanning occurs to search for one or more predefined secondary adherence signatures on diverted, paused, or otherwise set-aside data, without preventing continued scanning for other instances of the primary adherence signature.

Some embodiments described herein utilize or provide a cybersecurity method, which is performed by a computing system, and which includes forming a contiguous sensitive data identification data structure (SDIDS) in the computing system memory, the SDIDS including a predefined primary adherence signature having an instance frequency within a specified corpus of digital documents that is no greater than one in ten billion, ascertaining an identifiable sensitive data (ISD) within the SDIDS, and utilizing the SDIDS to improve security functioning of the computing system.

This SDIDS functionality has the technical benefit of reducing false positive detections of identifiable secrets. By making the detection depend on an extremely rare signature, false detections caused by coincidental presence of the signature bits in association with data other than identifiable secrets are avoided, or at least reduced.

Some embodiments described herein utilize or provide a cybersecurity method, which is performed by a computing system, and which includes forming a contiguous sensitive data identification data structure (SDIDS) in the computing system memory, the SDIDS including a predefined primary adherence signature which is internal to the SDIDS and hence not a prefix of the SDIDS, ascertaining an identifiable sensitive data (ISD) within the SDIDS, and utilizing the SDIDS to improve security functioning of the computing system.

This SDIDS functionality has the technical benefit of reducing or avoiding attempts to extract secrets when those attempts presume that the secrets are marked by a prefix signature. Such attempts may be well-intentioned but nonetheless problematic because they increase the risk of secrets exposure. Such attempts may also be malicious. Either way, placing the secrets identification signature in a data structure position that is not a prefix adjacent the secret itself tends to frustrate and deter these attempts at secret extraction.

In some embodiments, the method includes at least one of: embedding timestamp metadata in the SDIDS, or extracting embedded timestamp metadata from the SDIDS.

In some embodiments, this SDIDS functionality has the technical benefit of facilitating detection of security keys or other secrets which have expired, or which are within a specified tolerance of expiration, which promotes better governance of secrets. In some embodiments, this SDIDS functionality has the technical benefit of facilitating security incident investigations or minting mechanisms by marking security keys or other secrets which were minted within a specific time period.

In some embodiments, the method includes at least one of: embedding deployment metadata in the SDIDS, or extracting embedded deployment metadata from the SDIDS, and the deployment metadata represents at least one of: an authorized deployment cloud status of public, an authorized deployment cloud status of private, an authorized deployment cloud status of governmental, an authorized deployment cloud region identifier, an authorized deployment cloud tenant identifier, an authorized deployment cloud tenant class identifier, an authorized deployment data center identifier, an authorized deployment cloud account identifier, or an authorized sensitive data manager identifier.

This SDIDS functionality has the technical benefit of promoting secrets governance by associating information about the authorized deployment scope of a secret with the secret itself in a contiguous data structure. This avoids delays and access failures caused by alternate approaches that attempt to retrieve authorized deployment scope information about a secret from a location that is remote from the secret. A conflict between the actual deployment of the secret and the authorized deployment scope of the secret indicates not only that the secret has leaked outside that authorized scope, but also indicates along what path or to what extent the secret has leaked, e.g., outside an authorized data center, between tenants, or across a geographic region boundary.

In some embodiments, the method includes at least one of: embedding origination metadata in the SDIDS, or extracting embedded origination metadata from the SDIDS, and the origination metadata represents at least one of: a minting service identifier, a minting provider identifier, a minting cloud region identifier, a minting cloud tenant identifier, a minting cloud tenant class identifier, a minting data center identifier, or a minting cloud account identifier.

This SDIDS functionality has the technical benefit of promoting secrets governance by associating information about the origin of a secret with the secret itself in a contiguous data structure. This avoids delays and access failures caused by alternate approaches that attempt to retrieve origination information about a secret from a location that is remote from the secret. Knowing the secret's origin facilitates tracing the secret instance's path to its current location, whether or not that location is within the authorized deployment scope of the secret, which in turn facilitates validation or testing of security mechanisms that are—or might be—part of the secret instance's path.

In some embodiments, the method includes at least one of: embedding test metadata in the SDIDS, or extracting embedded test metadata from the SDIDS, and the test metadata indicates at least one of: the ISD is a test ISD whose unauthorized exposure is an acceptable risk event during testing of the security functioning of the computing system, the ISD is a test ISD whose unauthorized exposure is an expected event during testing of the security functioning of the computing system, or the SDIDS is a testing artifact having a fictional provider.

This SDIDS functionality has the technical benefit of facilitating validation or testing of security mechanisms without risking exposure of actual secrets. This is accomplished in some embodiments by providing test SDIDS which have the same syntax and semantics as non-test SDIDS but contain non-secret data in place of secret data.

In some embodiments, the method includes at least one of: embedding test behavior metadata in the SDIDS, or extracting embedded test behavior metadata from the SDIDS, and the test behavior metadata represents a test behavior, the test behavior including at least one of: hanging a system, raising an unhandled exception, requesting data from a server, or performing a cybersecurity protective action.

This SDIDS functionality has the technical benefit of facilitating validation or testing of security mechanisms without risking exposure of actual secrets, and with a focus on particular potentially problematic system behavior. This is accomplished in some embodiments by providing test SDIDS which have the same syntax and semantics as non-test SDIDS but (a) contain non-secret data in place of secret data, and (b) specify a test behavior.

In some embodiments, the ISD includes a security key, and utilizing the SDIDS to improve security functioning of the computing system includes utilizing a correlation identifier of the SDIDS by correlating the ISD across at least two of: a runtime deployment environment, a secrets store, a resource administration portal, or a key detection tool.

This SDIDS functionality has the technical benefit of facilitating validation or testing of security mechanisms, and promoting secrets governance, by matching instances of a secret with one another. This allows a leak investigation, for example, to determine whether a copy of a secret detected in a repository upload came from a resource admin portal or from a key vault (which is a kind of secrets store). Knowing the path taken by a copy of a secret helps identify and fix leaks along that path.

In some embodiments, the method includes scanning for an instance of the SDIDS at a speed of at least 100000 bytes per second.

This SDIDS functionality has the technical benefit of satisfying a better-than-human performance requirement. Any explicit better-than-human performance requirement emphasizes what a person of skill would already presume and acknowledge is implicit in all commercial embodiments—these embodiments are computer-implemented. They are not done in a person's mind, or with pen and paper. Scanning at this speed (or in many embodiments, even greater speed) permits scanning in real-time, or at least scanning without perceptible delays, which facilitates the adoption of scanning for identifiable secrets and thus promotes corresponding improvements in the protection of secrets in a computing system.

These and other benefits will be apparent to one of skill from the teachings provided herein.

### Operating Environments

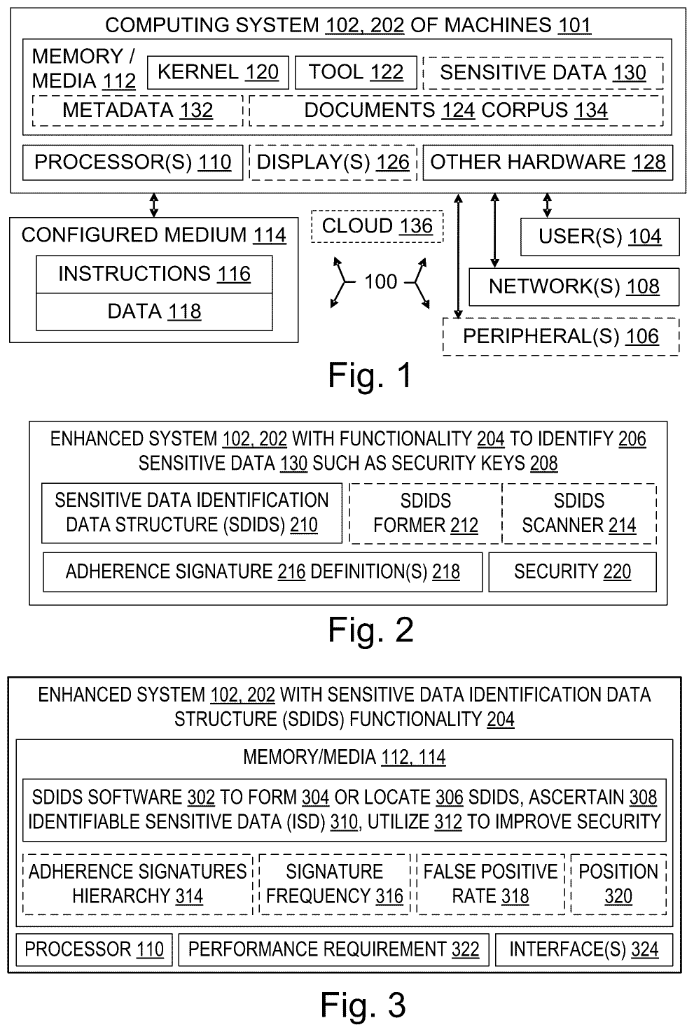

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 136. An individual machine is a computer system, and a network or other non-empty group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface by using displays 126, keyboards 106, and other peripherals 106, via typed text, touch, voice, movement, computer vision, gestures, and/or other forms of I/O. Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

The distinction between human-driven accounts and machine-driven accounts is a different distinction than the distinction between attacker-driven accounts and non-attacker driven accounts. A particular human-driven account may be attacker-driven, or non-attacker-driven, at a given point in time. Similarly, a particular machine-driven account may be attacker-driven, or non-attacker-driven, at a given point in time.

Although for convenience, examples and claims herein sometimes speak in terms of accounts, “account” means “account or session or both” unless stated otherwise. In this disclosure, including in the claims and elsewhere, a statement about activity by “the user account or the user session” does not mean that both the user account and the user session must be present. Instead, such a statement is to be understood as a pair of corresponding but distinct statements given as alternatives, one statement being about activity by the user account, and the other statement being about activity by the user session. Likewise, a characterization of “the user account or the user session” does not mean that both the user account and the user session must be present. Instead, such a characterization is to be understood as a pair of corresponding but distinct characterizations given as alternatives, one characterizing the user account, and the other characterizing the user session.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 136 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, mobile devices 102 or workstations 102 or servers 102, editors, compilers, debuggers and other software development tools, as well as APIs, browsers, or webpages and the corresponding software for protocols such as HTTPS, for example. Files, APIs, endpoints, and other resources may be accessed by an account or non-empty set of accounts, user or non-empty group of users, IP address or non-empty group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUS, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, SDIDS functionality 204 could be installed on an air gapped network 108 which includes both (a) an on-premises cloud portion or an off-premises cloud secured at the same or better level as a government cloud, and (b) a non-cloud on-premises network portion, and then be updated periodically or on occasion using removable media 114, or not be updated at all. Some examples of a “government cloud” include Salesforce® Government Cloud implementations at the time of filing of the present disclosure, Microsoft Azure® for US Government implementations at the time of filing of the present disclosure, and Amazon Web Services GovCloud™ implementations at the time of filing of the present disclosure (marks of their respective owners). Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, devices, data structures, kinds of data, settings, parameters, components, computational resources, programming languages, tools, workflows, or algorithm implementations, or other items in a computing environment, which are disclosed herein but not associated with a particular reference numeral herein. Corresponding drawings may also be added.

### More About Systems

FIG. 2 illustrates a computing system 102 configured by one or more of the SDIDS functionality enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. FIG. 2 items are discussed at various points herein.

FIG. 3 shows some aspects of some enhanced systems 202. Like FIG. 2, FIG. 3 is not a comprehensive summary of all aspects of enhanced systems 202 or all aspects of SDIDS functionality 204. Nor is either figure a comprehensive summary of all aspects of an environment 100 or system 202 or other context 864 of an enhanced system 202, or a comprehensive summary of any aspect of functionality 204 for potential use in or with a system 102. FIG. 3 items are discussed at various points herein.

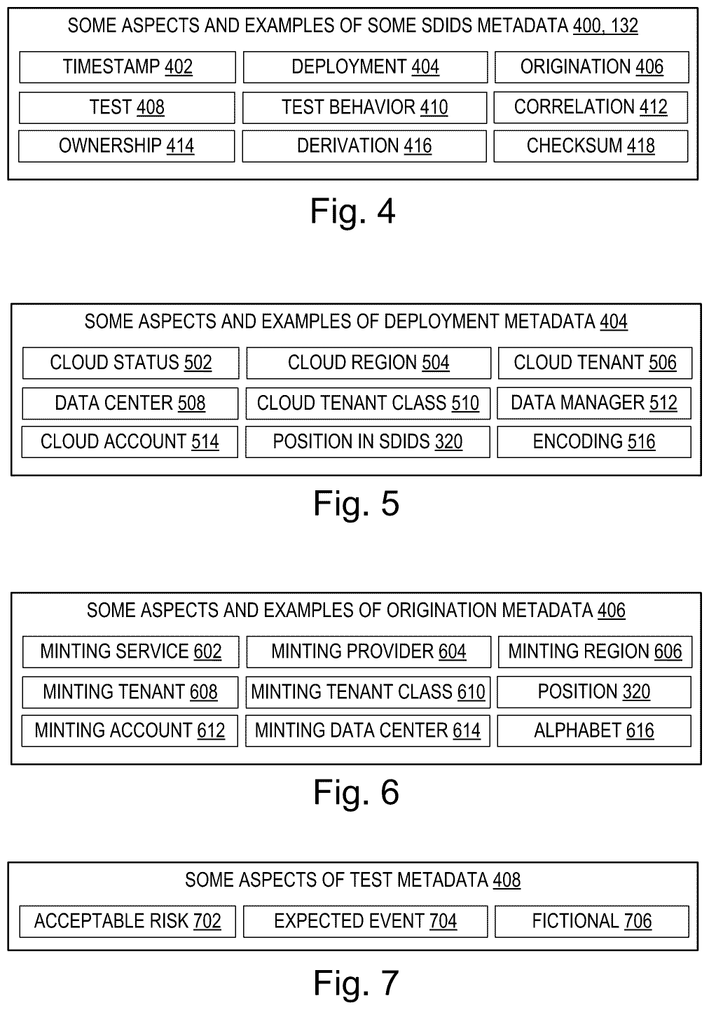

FIG. 4 is a block diagram illustrating aspects of SDIDS functionality 204 metadata 400 (a subset of metadata generally 132) in a computing system 102. FIG. 4 items are discussed at various points herein.

FIG. 5 shows some additional aspects related to SDIDS functionality 204 deployment metadata 404 (a subset of SDIDS metadata 400) in a computing system 102. FIG. 5 items are discussed at various points herein.

FIG. 6 shows some additional aspects related to SDIDS functionality 204 origination metadata 406 (a subset of SDIDS metadata 400) in a computing system 102. FIG. 6 items are discussed at various points herein.

FIG. 7 shows some additional aspects related to SDIDS functionality 204 test metadata 408 (a subset of SDIDS metadata 400) in a computing system 102. FIG. 7 items are discussed at various points herein.

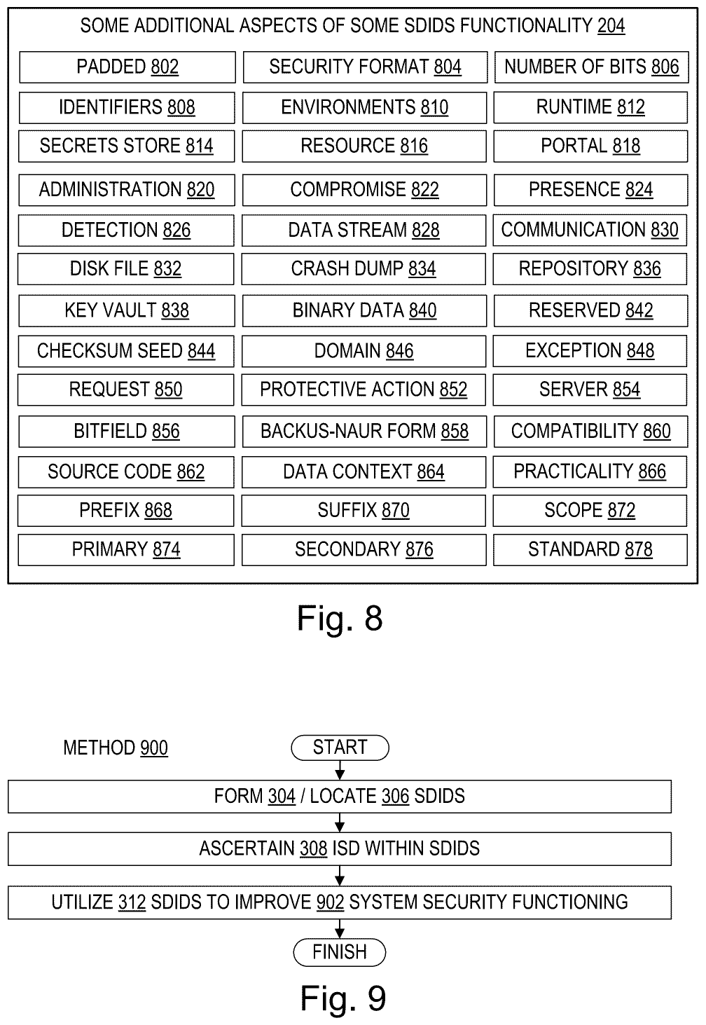

FIG. 8 shows some additional aspects related to SDIDS functionality 204 in a computing system 102. FIG. 8 items are discussed at various points herein.

FIGS. 1 through 8 are not individually or collectively a comprehensive summary of all aspects of SDIDS functionality 204.

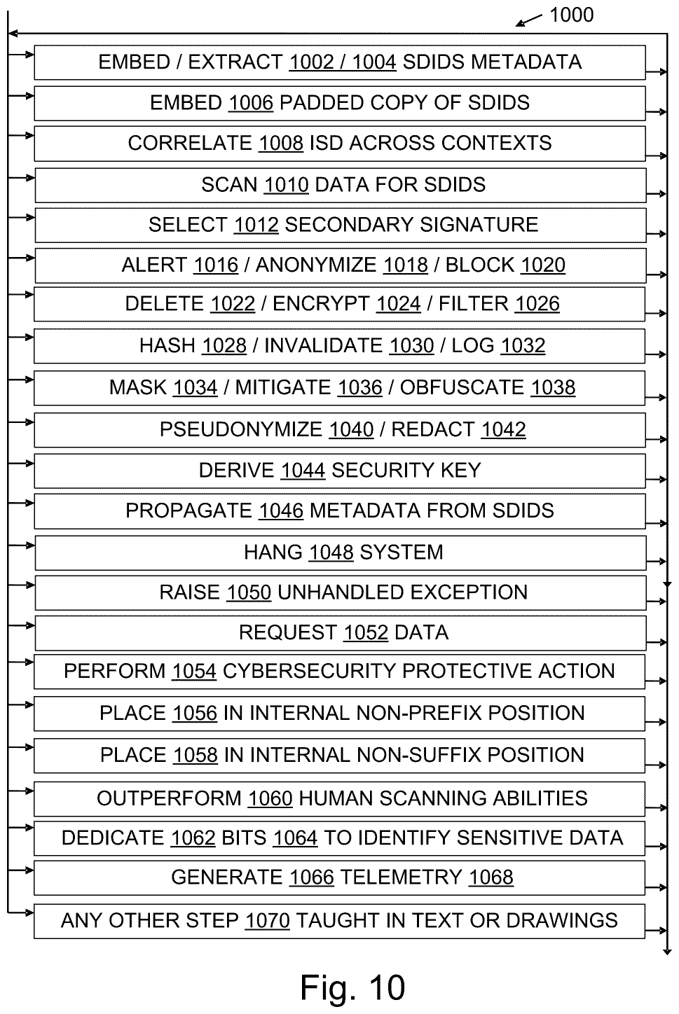

The other figures are also relevant to systems 202. FIGS. 9 and 10 are flowcharts which illustrate some methods of SDIDS functionality 204 operation in some systems 202.

In some embodiments, the enhanced system 202 is networked through an interface 324. In some, an interface 324 includes hardware such as network interface cards, software such as network stacks, APIs, or sockets, combination items such as network connections, or a combination thereof.

Some embodiments include a computing system 202 which is configured to utilize or provide SDIDS functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous block or of a single kind, e.g., a memory 112 may include hard drive memory as well as volatile RAM, and may include memories that are physically located on different machines 101. Similarly, the phrase “processor set” is used to emphasize that a processor 110 is not necessarily confined to a single chip or a single machine 101.

All sets herein are non-empty unless described otherwise.

Some embodiments provide or utilize a computing system 202, the computing system having access to a corpus 134 of digital documents 124 which includes at least one terabyte of data 118. An alternate corpus minimum size requirement in some embodiments is one gigabyte. The corpus itself is not part of an embodiment, but it is relevant because the corpus includes the documents that will be scanned (or will be made available to be scanned) by the relevant embodiment for instances of secrets 310, or will be marked by the relevant embodiment with signature(s) identifying instances of secrets 310, or both.

Some examples of a suitable corpus (assuming the applicable size requirement is met) include documents 124 on a specified server 854 or a specified set of servers or in a specified file 832 or a specified set of files (e.g., a specified database or other storage artifact) or a specified cloud 136 or set of clouds, documents 124 on a specified network 108 or specified set of networks, documents 124 having a specified date characteristic 402, e.g., documents created/modified/copied within a specified timestamp range, documents 124 having a specified ownership characteristic 414, e.g., documents belonging to a specified tenant 506 or tenant class 510, and a corpus otherwise defined as documents 124 having a specified metadata characteristic 132 or a specified location in a computing environment 100. In some embodiments, some examples of ownership metadata 414 are: a customer id, a billing id, a subscription id, a portion or transformation of a readable owner identifier, a user name or code, an account, or an organization name.

The computing system 202 includes a digital hardware memory, also referred to simply as a memory 112. This is part of the computing system, not part of a human person. The computing system 202 also includes a processor set including at least one hardware processor, also referred to simply as a processor 110. This is part of the computing system, not part of a human person. Expecting a human to routinely scan gigabytes or more of data for a signature without making risky mistakes and causing unnecessary large delays in data processing is not realistic. The processor set is in operable communication with the digital hardware memory, e.g., via electronic signals. Again, these are electronic signals within the computing system, not in a human person.

In some embodiments, the computing system includes and thus is configured functionally by a cybersecurity software 302 which upon execution by the processor set (i) forms 304 a contiguous sensitive data identification data structure (SDIDS) 210 in the hardware memory, the SDIDS including at least one of: (a) a predefined primary adherence signature 216 plus a predefined secondary adherence signature 216 in a hierarchy 314 whereby the predefined secondary adherence signature is selected 1012 from a plurality of predefined secondary adherence signatures which are each associated with a respective nonempty proper subset of a nonempty set of SDIDS instances, each SDIDS instance having the predefined primary adherence signature, (b) the predefined primary adherence signature having an instance frequency 316 within the corpus 134 of digital documents 124 that is no greater than one in ten billion, or (c) the predefined primary adherence signature being internal 1056 to the SDIDS and hence not being a prefix 868 of the SDIDS, (ii) ascertains 308 an identifiable sensitive data (ISD) 310 within the SDIDS, and (iii) utilizes 312 the SDIDS to improve 902 security functioning 220 of the computing system.

In some embodiments, the SDIDS includes at least N of the following security enhancement items, where N is in the range from 1 to 8 and is dependent on the embodiment: timestamp metadata embedded in the SDIDS, deployment metadata embedded in the SDIDS, origination metadata embedded in the SDIDS, test metadata embedded in the SDIDS, test behavior metadata embedded in the SDIDS, derivation metadata embedded in the SDIDS, ownership metadata embedded in the SDIDS, or a correlation identifier embedded in the SDIDS.

Other system embodiments are also described herein, either directly or derivable as system versions of described processes or configured media, duly informed by the extensive discussion herein of computing hardware.

Although specific SDIDS architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of SDIDS functionality, for example, as well as different technical features, aspects, interfaces, mechanisms, software, expressions, operational sequences, commands, data structures, programming environments, execution environments, environment or system characteristics, agents, proxies, or other functionality consistent with teachings provided herein, and may otherwise depart from the particular examples provided.

Processes (a.k.a. Methods)

Processes (which are also be referred to as “methods” in the legal sense of that word) are illustrated in various ways herein, both in text and in drawing figures. FIGS. 9 and 10 each illustrate a family of methods 900 and 1000 respectively, which are performed or assisted by some enhanced systems, such as some systems 202 or another SDIDS functionality enhanced system as taught herein. Method family 900 is a proper subset of method family 1000. Moreover, activities identified in FIGS. 2, 3, and 8 include explicit or implicit method steps, which are likewise incorporated into method (a.k.a. process) 1000. These diagrams and flowcharts are merely examples; as noted elsewhere, any operable combination of steps that are disclosed herein may be part of a given embodiment when called out in a claim.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types or speaks an input such as a particular value for a document name or a storage location of a document 124. Such input is captured in the system 202 as digital text, or captured as digital audio which is then converted to digital text. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 10. FIG. 10 is a supplemental portion of the textual and figure drawing examples of embodiments provided herein and the descriptions of embodiments provided herein. In the event of any alleged inconsistency, lack of clarity, or excessive breadth due to an interpretation of FIG. 10, the content of this disclosure shall prevail over that interpretation of FIG. 10.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 1000 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 10 to be non-operable, the sequence S is not within the scope of any claim. Any assertion otherwise is contrary to the present disclosure.

Some embodiments provide or utilize a cybersecurity method 1000 which is performed by a computing system, the computer system having a hardware memory in operable communication with a hardware processor, the computer system having scanning access to a corpus of digital documents which has a predefined scope 872. This method 1000 includes automatically: forming 304 a contiguous sensitive data identification data structure (SDIDS) in the hardware memory, the SDIDS including at least one of: (a) a predefined primary adherence signature plus a predefined secondary adherence signature in a hierarchy whereby the predefined secondary adherence signature is selected from a plurality of predefined secondary adherence signatures which are each associated with a respective nonempty proper subset of a nonempty set of SDIDS instances, each SDIDS instance having the predefined primary adherence signature, (b) the predefined primary adherence signature having an instance frequency within the corpus of digital documents that is no greater than one in ten billion, or (c) the predefined primary adherence signature being internal to the SDIDS and hence not being a prefix of the SDIDS; ascertaining 308 an identifiable sensitive data (ISD) within the SDIDS; and utilizing 312 the SDIDS to improve 902 security functioning of the computing system.

Here, as elsewhere herein, improving 902 security functioning means optimizing security functioning, e.g., by reducing or removing a security vulnerability, by improving security incident investigation effectiveness or efficiency, by improving cyberattack mitigation or recovery effectiveness or efficiency, by reducing friction encountered by users as a result of security operations without also reducing security effectiveness, by increasing operational auditability with respect to security, or by any of the other technical benefits or improvements noted herein or apparent to one of skill in view of the present disclosure.

In some embodiments, the method 1000 includes at least one of: embedding 1002 timestamp metadata 402 in the SDIDS, or extracting 1004 embedded timestamp metadata from the SDIDS. This timestamp metadata 402 can be used, e.g., to determine whether a security key has expired. A given embodiment includes zero or more multiple timestamps in an SDIDS, e.g., an SDIDS can include the time of a security key allocation as well as its expiry or length of validity.

In some embodiments, the method 1000 includes at least one of: embedding 1002 deployment metadata 404 in the SDIDS, or extracting 1004 embedded deployment metadata from the SDIDS, wherein the deployment metadata represents at least one of: an authorized deployment cloud status 502 of public, an authorized deployment cloud status 502 of private (e.g., air-gapped), an authorized deployment cloud status 502 of governmental, an authorized deployment cloud region 504 identifier, an authorized deployment cloud tenant 506 identifier, an authorized deployment cloud tenant class 510 identifier, an authorized deployment data center 508 identifier, an authorized deployment cloud account 514 identifier, an authorized sensitive data manager 512 identifier, an authorized deployment cloud status 502 of development test environment, or an authorized deployment cloud status 502 of preproduction environment. A development test environment constitutes execution in unit tests, local machine testing and/or a dedicated dev test fabric or runtime environment. Preproduction is a staging environment in advance of full deployment to drive testing in a high-fidelity environment which is close to a production environment. This deployment metadata can be used, e.g., to determine whether the sensitive data has leaked outside an authorized deployment. The authorized sensitive data manager identifier can be used to determine, e.g., whether sensitive data is customer-managed or is instead a service-managed secret.

In some embodiments, the method 1000 includes at least one of: embedding 1002 origination metadata 406 in the SDIDS, or extracting 1004 embedded origination metadata from the SDIDS, wherein the origination metadata represents at least one of: a minting service 602 identifier, a minting provider 604 identifier, a minting cloud region 606 identifier, a minting cloud tenant 608 identifier, a minting cloud tenant class 610 identifier, a minting data center 614 identifier, or a minting cloud account 612 identifier. This origination metadata can supplement the secondary adherence signature's identification of a provider, e.g., to determine which particular service or which particular version of the provider generated a key, or to identify another provider which also participated in key generation.

In some embodiments, the method 1000 includes at least one of: embedding 1002 test metadata 408 in the SDIDS, or extracting 1004 embedded test metadata from the SDIDS, the test metadata indicating at least one of: the ISD 310 is a test ISD whose unauthorized exposure is an acceptable risk 702 event during testing of the security functioning of the computing system, the ISD is a test ISD whose unauthorized exposure is an expected event 704 during testing of the security functioning of the computing system, or the SDIDS is a testing artifact having a fictional provider 706.

In some embodiments, utilizing 312 the SDIDS to improve security functioning of the computing system includes embedding 1006 a padded 802 copy of the SDIDS in a document in conformance with a security format 804 which dedicates 1062 more bits 1064 to identification 206 of sensitive data 130 than are dedicated in the SDIDS. This supports compatibility 860, e.g., a hot swap of key generators, in some scenarios, by leaving the length of an HIS key variable unchanged even though the content of the key is replaced by HIS v2 data which is defined to have fewer bits than the HIS key.

In some embodiments, utilizing 312 the SDIDS to improve security functioning of the computing system includes utilizing a correlation 412 identifier of the SDIDS by correlating 1008 the ISD across at least two of: a runtime 812 deployment environment 810, a secrets store 814, a resource 816 administration 820 portal 818, 122, or a sensitive data compromise 822 detection tool 122. In a given embodiment, the “runtime” corresponds to execution time, or to system software (e.g., a kernel 120 or a common language runtime) which supports execution, or both.

In some embodiments, the ISD 310 includes a security key 208, and utilizing 312 the SDIDS to improve security functioning of the computing system includes utilizing a correlation 412 identifier of the SDIDS by correlating 1008 the ISD across at least three of: a runtime deployment environment, a secrets store, a resource administration portal 818, or a key compromise detection tool, or a key detection tool, or a sensitive data detection tool. In some scenarios, an administrator logs into the resource administration portal and receives notifications of security assets correlated to well-known exposures, and receives a prompt to invalidate or rotate compromised keys.

In some embodiments, operations performed by a sensitive data compromise detection tool include detection 826 scenarios, e.g., detecting exposures as well as a reporting service where researchers submit exposed keys, as well as a public store of well-known compromised keys, etc. Some tools 122 detect an SDIDS presence 824 which is not necessarily a compromise. In some cases, this functionality classifies or records the presence of sensitive data in an environment where it is not compromised. In some scenarios a real-time agent on a machine tracks sensitive data and alerts when a process unexpectedly records a secret to a local file. In another example, a scanner traverses a secured database looking for persisted SDIDS, to classify specific records and SDID instances or to compute a sensitivity or degree of compromise rating, or both.

In some embodiments, utilizing 312 the SDIDS to improve security functioning of the computing system includes scanning 1010 for an instance of the SDIDS in at least one of: a data stream 828, a network communication 830, a nonempty set of disk files 832, a memory 112 at runtime, a crash dump 834, a software repository 836 communication upload 830, a cloud key vault 838, 814, a nonempty set of digital documents 124, or a nonempty set of binary data 840, 118.

Some examples of scanning a data stream include scanning files on disk, walking memory at runtime, scanning rendered web pages, processing crash dumps, and scanning other binary formats.

As more particular examples, in some scenarios an embodiment scans 1010 one of more of the following for an SDIDS: work items, tickets and other engineering and servicing artifacts, productivity documents (word processor files, spreadsheets, presentations, messaging channels, messaging conversations, messaging threads, email communications, etc.), browser-rendered or server-rendered web content, locally updated files, locally ingressed files on disk, zip and other archive files, images, other compressed or archive formats, other binary file formats that require parsing or deserialization, or databases.

For example, in some embodiments a key vault crawler scans 1010 data in a secrets store and generates 1066 telemetry 1068 using a cross-correlation ID 412, functioning as a secret's watermark. This permits the embodiment to determine, e.g., whether a secret in the key vault appears in a repository upload or an email, and helps incident investigators find the possible owner of the secret.

Some embodiments provide or utilize a cybersecurity method 1000 which is performed by a computing system, the computer system having a hardware memory in operable communication with a hardware processor, the computer system having scanning access to a corpus of digital documents which has a predefined scope 872. This method 1000 includes automatically: locating 306 a contiguous sensitive data identification data structure (SDIDS) in the hardware memory at least in part by scanning, the scanning having a false positive frequency 318 within the corpus of digital documents that is no greater than one in twenty billion, the SDIDS including at least one of: (a) a predefined primary adherence signature plus a predefined secondary adherence signature in a hierarchy whereby the predefined secondary adherence signature is selected from a plurality of predefined secondary adherence signatures which are each associated with a respective nonempty proper subset of a nonempty set of SDIDS instances, each SDIDS instance having the predefined primary adherence signature, (b) the predefined primary adherence signature having an instance frequency within the corpus of digital documents that is no greater than one in one billion, or (c) the predefined primary adherence signature being internal to the SDIDS and hence not being a prefix of the SDIDS; ascertaining 308 an identifiable sensitive data (ISD) within the SDIDS; and utilizing 312 the SDIDS to improve 902 security functioning of the computing system. In some variations, an implementation has a 4-character fixed signature in a base62 alphabet, with a chance of collision of 4\hat{ }62 or 1 in about fifteen billion. In some, a 5-character bas62-encoded signature reduces the chance of collision further, to less than 1 in about twenty billion.

In some embodiments, the scanning 1010 scans for an instance of the SDIDS at a speed of at least 100000 bytes per second. That is, the scanning satisfies a performance requirement 322 which requires scanning for an instance of the SDIDS at a speed of at least 100000 bytes per second; in practice, the scanning scans for an instance of the SDIDS adherence signature 216. This scanning speed outperforms 1060 human scanning abilities, as is evident from how the performance requirement 322 was formulated. The 100000 bytes per second is meant to make it very clear that human speed is too slow in this embodiment (and also in every other embodiment, unless expressly stated otherwise). The fastest alleged human speed reading is 80000 words per minute=1334 words per second, and assuming 10-byte words gives 13340 bytes per second. The average length of an English word is 4.7 characters, representable in 5 bytes. Thus, 100000 bytes per second is presumptively faster than any human person can scan data for an instance of the SDIDS adherence signature 216, in the absence of credible evidence otherwise.

In some embodiments, utilizing 312 the SDIDS to improve security functioning of the computing system includes at least one of: alerting 1016, anonymizing 1018, blocking 1020, correlating 1008, deleting 1022, encrypting 1024, filtering 1026, hashing 1028, invalidating 1030, logging 1032, masking 1034, mitigating 1036, obfuscating 1038, pseudonymizing 1040, or redacting 1042. In some embodiments, invalidating 1030 includes creating a ticket to invalidate one or more keys.

For example, in some data stream scanning scenarios, the embodiment locates 306 an adherence signature in the data stream, redacts 1042 the corresponding SDIDS (including secret 310) from the data stream, alerts 1016 an administrator, and logs 1032 these actions. As another example, in some repository upload scanning scenarios, the embodiment locates 306 an adherence signature in code which is being uploaded to a repository, blocks 1020 the upload, and applies a filter 1026 and masking 1034 to display the masked secret in context with the preceding three lines of code and the following three lines of code. In a further example, the embodiment locates 306 an adherence signature in data which is being exfiltrated 830 by an account 514 that was created less than one hour ago, blocks 1020 the exfiltration, and invalidates 1030 the account to prevent further exfiltration attempts by the account. One of skill will contemplate many other scenarios consistent with the teachings herein.

In some embodiments, utilizing 312 the SDIDS to improve security functioning of the computing system includes at least one of: deriving 1044 a security key, propagating 1046 at least a portion of metadata from the SDIDS, or embedding 1002 a derivation metadata 416 into the SDIDS.

In some embodiments, key derivation 1044 includes one or more of: generating a secret key from one or more master keys, or one or more passwords, or one or more pass phrases, or using a pseudorandom function, or stretching a key into a longer key, or a combination of the foregoing. In some embodiments, a secret from which an embodiment derives a new identifiable key is itself an identifiable key, from which the embodiment in some scenarios obtains and flows forward metadata into the derived key. Some embodiments do not require the key derivation function (KDF) secret to include an identifiable key, but the output is an identifiable key. In some scenarios, a derivation key generation logic is parameterized by the metadata 400, such as origination metadata or deployment metadata.

As to encoding 516 metadata 400, some embodiments employ one or more of the following techniques: persisting metadata in whole or part, transforming metadata data (e.g., by hashing) and incorporating that transformation in whole or part, or assigning a static bitwise value for a metadata (e.g., USWEST region is value of 0, USEAST is value 1) and incorporating that static bitwise value.

In some embodiments, the method 1000 includes at least one of: embedding 1002 seeded 844 checksum 418 metadata in the SDIDS, or extracting 1004 embedded seeded checksum metadata from the SDIDS.

In some embodiments, the method 1000 includes at least one of: embedding 1002 test behavior metadata 410 in the SDIDS, or extracting 1004 embedded test behavior metadata from the SDIDS, the test behavior metadata representing a test behavior 410, the test behavior including at least one of: hanging 1048 a system, raising 1050 an unhandled exception 848, requesting 1052 data from a server 854, or performing 1054 a cybersecurity protective action 852. Protective actions include computational actions which improve 902 security 220.

### Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, can be configured in the embodiment using items such as SDIDS software 302 with a former 212 that forms 304 SDIDSs (e.g., writes the data to the specified SDIDS bitfields) or a scanner 214 that scans 1010 for SDIDSs, SDIDSs 210, a hierarchy 314 of definitions 218 of adherence signatures 216, SDIDS metadata 400, and security data structures and mechanisms 220, in the form of data 118 and instructions 116, read from a removable storage medium 114 and/or another source such as a network connection, to form a configured storage medium. The foregoing examples are not necessarily mutually exclusive of one another. The configured storage medium 112 is capable of causing a computer system 202 to perform technical process steps for providing or utilizing SDIDS functionality 204 as disclosed herein. The Figures thus help illustrate configured storage media embodiments and process (a.k.a. method) embodiments, as well as system and process embodiments. In particular, any of the method steps illustrated in FIGS. 9 and 10, or otherwise taught herein, may be used to help configure a storage medium to form a configured storage medium embodiment.

Using a hierarchy of signatures that provides advantages. Specifically, scan tools and other systems can author detections for any access key that implements the standard in general sch that those scanners do not necessarily perform any additional work to further classify the secrets. This makes it possible for a scanner to author a single detection that will permanently provide value, without further updating, no matter what future uptake of the standard exists. This also puts a cap on performance costs to make the SDIDS detection. It allows a single regex (or a single highly tuned string comparison function) to enable real-time detection scenarios that are otherwise impossible.

Some embodiments use or provide a computer-readable storage device 112, 114 configured with data 118 and instructions 116 which upon execution by a processor 110 cause a computing system 202 to perform a method 1000. This includes any method 1000 herein, whether described explicitly or implicitly apparent to one of skill in the art.

### Additional Observations

Additional support for the discussion of NASS functionality 204 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, best mode, novelty, nonobviousness, inventive step, or industrial applicability. Any apparent conflict with any other patent disclosure, even from the owner of the present subject matter, has no role in interpreting the claims presented in this patent disclosure. It is in the context of this understanding, which pertains to all parts of the present disclosure, that examples and observations are offered herein.

Many secrets such as passwords and security keys are highly anonymous in form. As a result, they are easily exposed in a variety of documents, in source code and through other data sources. This leads to malicious exploitation. However, by applying teaching provided herein, systems can annotate secrets in a manner that makes it possible to detect them with nearly perfect accuracy. Furthermore, techniques taught herein permit sufficiently efficient detection to enable blocking or redaction in real-time data generation scenarios. In addition, some techniques taught herein encode additional details that support otherwise unavailable secret hygiene controls.

In some embodiments, a risk window is greatly reduced by reserving additional bits in generated security key SDIDSs to provide additional metadata relevant to security responses. Because this data is represented in the SDIDS itself, e.g., in formats referred to herein as HIS v2, scanners and other tools can immediately obtain and act on it, rather than depending on the availability of telemetry and other discoverability services provided by secrets' issuers. “HIS v2” refers to some examples of embodiments, but teachings and embodiments herein are not limited to the HIS v2 examples except as plainly stated in the claims.

Also, “HIS v2 key” refers to an entire SDIDS 210, not merely to a security key 208 portion within the ISD 310 of the SDIDS, unless indicated otherwise.

One approach combines HIS v2 keys with a central key generation mechanism, which permits less metadata to be embedded (and thereby, exposed) in the key. In some scenarios, a centralized service has precise telemetry for every allocated key generated by the central key generation mechanism, and serves as a definitive oracle for at least part of the metadata. However, this approach involves not only a key minting service but maintaining a discoverability service for key metadata, with all the corresponding costs and complexity. By contrast, in some embodiments metadata can be extracted directly from keys and inspected, which optimizes efficiency, and avoids network calls.

In some embodiments and scenarios, embedded metadata which is useful in governance of security keys and efficient response when keys are leaked includes a 1P vs. 3P distinction 414, e.g., whether the key is a service provider's (1P, indicating e.g., a cloud service provider's own security keys) vs. a leaked customer key (3P, e.g., a key that has been incorrectly saved to a cloud service provider's support ticket). These ownerships are handled differently. 1P exposures should be urgently and efficiently addressed. The service provider, e.g., Microsoft, normally has significant latitude in handling this class of exposure, e.g., because they can assume the business risk associated with revoking exposed keys. 3P keys should be handled differently to protect the customer's interests and to satisfy regulatory requirements and compliance requirements. Accordingly, in some embodiments HIS v2 keys enable distinguishing 1P vs. 3P keys, e.g., via an embedded metadata bit 414 in the HIS v2 keys. Being able to separate 1P from 3P allocations assists enforcement of rotation hygiene by examining allocation data. Determining during key generation whether a particular key is 1P or 3P is straightforward in some situations, and is difficult or not feasible in other situations. However, for those situations where the distinction can be made, some embodiments support capturing the distinction in metadata 400 burned into a key.

In some embodiments and scenarios, embedded metadata 400, 510, 610 also or instead distinguishes between high-privilege cloud tenants and low-privilege cloud tenants, where privilege pertains to the level or scope or both of access permissions. In some such embodiments, a governance capability ensures that a secrets store (e.g., an Azure® Key Vault instance) will block import of security keys that cross a high-privilege to low-privilege boundary per the metadata.

In some embodiments and scenarios, embedded metadata 400 also or instead describe and supports enforcing cloud 136 and region 504, 606 boundaries. This is useful for governance and reliability, such as with some government clouds or in other circumstances which also call for stringent data isolation, in some cases also with other requirements for specific cloud instances. Encoding cloud instance data in secrets allows for strict management of keys in a secrets store, e.g., to prevent importation of secrets into the store that are not consistent with other keys in the store. Some scenarios include dropping reports of exposures if the reporting or logging itself is not limited to be resident within a specified cloud instance. In some scenarios, a testing component actively exercises a secret to determine its exploitability. In some embodiments, a cloud metadata designation in the key helps a test component avoid validating a key, so exercising the key is not possible, e.g., when the secret was minted within an air-gapped cloud, or was minted within a cloud instance for which network hardening makes testing infeasible from the test environment.

In some embodiments and scenarios, embedded metadata 400 also or instead include information 402 on time of key allocation. This is useful for identifying secrets that are out-of-policy for rotation per a service level agreement (SLA).

However, HIS v2 key consumers are expected to treat generated keys 210 as a single unit of uninterpreted, randomized data for the literal application of a key in a service execution context 864. For example, no encoded element of the key 210, such as a tenant id 506, 608, shall be evaluated to form a tid claim in a token issued by a security token service.

In some embodiments and scenarios, embedded metadata 400 also or instead implement granular information on key permissions. In some scenarios, this supplements or refines a rough bucketing of high vs. low privilege keys provided by some resource providers using a distinct checksum seed to allocate their HIS key.

In some embodiments and scenarios, embedded metadata 400 also or instead include one or more bits reserved 842 for provider-specific use. In some, embedded metadata also or instead include one or more bits reserved for global use as new scenarios materialize. For instance, some of these bits could be repurposed to increase the entropy of the keys themselves.

Some providers that have adopted HIS v1 have a variety of requirements around key length and format. In general, any increase in key length or key symbol set may cause compatibility problems. HIS v2 will result in longer keys for many providers; accordingly, some embodiments include a length increase expected to work indefinitely (i.e., not require increasing further in the future).

As far as key alphabet 616 is concerned, HIS v2 eliminates compatibility concerns by utilizing a lowest common denominator key symbol set. This alphabet excludes special characters that must be encoded in URLs (Uniform Resource Locators) or that may otherwise cause issues in displaying or transmitting them.

HIS v1 signatures manifest an Azure® access key format. HIS v1 signatures are not constrained to the base62 character set. In practice, only the special character ‘+’ has been encoded in some provider HIS v2 signatures, but SDIDS as defined herein does not preclude an embodiment that contains ‘+’ or other HIS v2 forbidden special characters in keys such as ‘/’ and the URL safe special chars ‘−’ and ‘_’, unless stated otherwise for a particular SDIDS embodiment. HIS v1 signatures have a single form that is case-sensitive. For HIS v2, in at least some scenarios providers with a signature that includes a ‘+’ sign replace this character. Because HIS v2 specifies two forms for signatures, an upper-case and lower-case form, every HIS v1 signature will change.

Due to an increase in the number of characters reserved as a fixed signature in an HIS v2 key, there is arguably no practical 866 need to include a checksum 418 for accuracy reasons. HIS v1 uses checksum seeds 844 (combined with the seed-driven Marvin checksum algorithm) to watermark specific categories of keys (e.g., high vs. low privilege keys). In some embodiments, this watermarking is replaced by utilizing provider-specific reserved characters instead. For convenience, the checksum approach can be retained to be utilized by HIS v1 adopters that want an expedient upgrade path to HIS v2.

As with HIS v1, metadata that is directly expressed or inferable from the security key itself may provide useful information to attackers when keys are leaked. Any compromise of a data store that itself provides something like time-of-creation, resource names+cloud/region/tenant data would provide some linkage to keys and could clearly provide value to an attacker. Accordingly, any proposed key 210 embedded metadata 400 addition in a particular computing environment should be reviewed under the threat model(s) pertinent to that computing environment. However, it is contemplated that in many embodiments and scenarios the value obtained from encoding specific data 400 overrides the informational value of encoding anything at all in the key. For example, with the timestamp encoded, a system can enforce stringent (auto) rotation of keys, which puts a fixed time window on the value of data encoded in the key. That rotation discipline would increase security. Also, HIS v2 strictly enforces the presence of at least 256 bits of entropy in a key's randomized component, as recommended by the Microsoft Crypto board to ensure cryptographic resilience in a post-quantum world. However, some SDIDS embodiments only enforce at least 128 bits of entropy in a key's randomized component, which is apparently unbreakable under current public technologies.

In some embodiments, reserving at least four characters to serve as a fixed signature in a key's encoded form (as is specified in HIS v1) enables a high degree of accuracy strictly in a first-pass detection phase driven by a regex engine 214. HIS v2 increases the quantity of fixed encoded characters (e.g., to six characters in some examples), effectively driving noise rates to zero strictly in the regex pass 1010. The checksum is still available for certain scenarios, such as detecting keys that a user has killed by modifying one or more characters in a generated key. A checksum also protects against the possibility of another data generator that produces patterns that conform to the format.

As to detection performance, there are several non-back-tracking regex engines 214 that provide excellent performance, e.g., Google's RE2 engine (which is incorporated in Kusto) and an extension to .NET's own built-in regex functionality included in .NET 7.0 or later. Even so, scan performance degrades as new patterns are authored, each of which is executed against a textual file.

In .NET, executing a string. IndexOf operation 214 against a file is 15 to 20 times faster than executing a simple regex using a performant non-back-tracking engine. Microsoft's scan tools take advantage of HIS v1's four-character fixed signature by applying an IndexOf check against this data as a pre-check to avoid scanning content that will never match the more expensive regex. In some embodiments, HIS v2 extends this performance gain further by enabling a general pre-check for any HIS v2 token. A single high performance IndexOf scan 214 is able to filter away files in which there is no possibility of matching an HIS v2 conformant provider, no matter how many of them exist now or in the future.

This is accomplished in some embodiments by defining a fixed primary adherence signature 216 for HIS v2 itself, in addition to any fixed secondary adherence signature defined by a specific security model. A secondary adherence signature for all of Azure Storage is AZST, for example.

With respect to testing and documentation, HIS v2 enables more powerful automated detection and response, and in some scenarios the format 804 specifies keys that are designed strictly for testing these features. This allows rapid and secure development of new analysis capabilities without exposing actual resource keys. Due to the extremely high levels of accuracy defined by the HIS v2 format, test keys are designed-in and defined as a built-in functionality 408, 410, or both, of some embodiments; merely modifying actual keys for use as test keys, or attempting to author an ad hoc fictional key, will produce a value that is discarded by an HIS v2 processor as a false positive.

The availability of keys that conform to the format of actual secrets but are non-functional is also useful for documentation purposes and product emulators.

HIS v2 Details. The following describes one set of embodiments, in the form of a detailed implementation of HIS v2. Other implementations of HIS v2 which comply with the teachings herein are also possible. Moreover, embodiments of the teachings do not necessarily comply with any HIS v2 format, e.g., an embodiment can differ as to whether a particular kind of metadata 400 is embedded in the key 210, the order of metadata fields 856 within a key 210, the location 320 of the adherence signature 216 among the other bits of the key identification data structure that includes the key 310 and the predefined adherence signature, the overall number 806 of bits 1064 in the key identification data structure 210, and other aspects. Embodiments are defined by the claims in view of the specification's disclosure.

This example presumes that services do not make any authorization decisions on any of the embedded watermarks or other metadata 400. For instance, a tenant code embedded in the key is not treated as equivalent to the tid claim in a security token service (STS) issued token. This doesn't mean a key store (e.g., Azure® KeyVault store) can't statically block a key from being imported in a non-compliant cross-tenant manner.

In this example, the adherence signature is not a prefix 868 of the key 310. Avoiding the prefix location reduces security control subversion and human mishandling of secrets, by making it harder to determine that the adherence signature is predefined fixed data.

In this example, the format includes a four-character fixed signature 216 portion for the standard 878 itself, referred to as the adherence signature, which is “JQQJ” to drive scan efficiency, but other suitably rare character sequences can be used in other embodiments. In some scenarios, a following ‘9’ character is reserved data which encodes metadata general to the standard itself, i.e., nothing provider-specific. In some scenarios, final character of a six-character adherence signature is a ‘9’ (reserved), or a ‘D’ (indicating a key derived from another HIS v2 key), or an ‘H’ (indicating an HIS v2 key derived using a non-HIS v2 secret). Some embodiments use Contains/IndexOf 214 to perform a search with excellent efficiency. Regardless of the specific literal in the adherence signature (presuming it meets a defined rarity level), when a fixed literal is shared for all HIS v2 keys, embodiments benefit from that search efficiency no matter how many providers end up implementing the standard, e.g., a Contains check 214 will eliminate all data with no HIS v2 exposure. After passing that preliminary check, Contains can be used on the provider-specific signature (the secondary adherence signature), as another efficiency mechanism to filter away regex calls for data with no per-provider exposure.

In this example, HIS v2 keys include a 63-byte base64-encoded (and base64-decodable) value.

Some implementations drop a trailing ‘=’ sign, which character isn't entirely compatible with URLs, hence requiring encoding. Some implementations are designed to trigger as few issues as possible with the character set 616. This is accomplished by excluding all special characters. Some resource providers scrub for all special characters, so injecting them could create a compatibility problem. HIS v2 favors data alignment along strict 6-bit boundaries, so an implementation can generate a 64-byte key 210 for storage where everything is in the right place. This form will include all 4 bytes of the checksum and two trailing ‘=’ sign characters. After dropping the final base64 encoded character and the two trailing equals signs, the data that remains conforms to the HIS v2 standard 878 and is verifiable on its own. Some embodiments obtain this compatibility by reducing the standard HIS v2 size to 63 bytes. Storage providers and other services can retain the 64-byte form for compatibility if that is helpful to them.

Although they are base64-decodable in this example, HIS v2-conformant keys 210 do not contain special characters, e.g., ‘+’ or ‘/’. Only alphanumeric characters 616 are permissible in the key 310, and in the key identification data structure 210 that includes the key 310 and the predefined adherence signature. In some cases, a randomized component includes 68 base62-encoded characters after removal of the two special characters. This drops the entropy per encoded character from 6 bits to something a bit less, resulting in overall entropy of approximately 396 bits. Some SDIDS embodiments have approximately 312 bits of overall entropy. Regardless, unless stated otherwise an SDIDS embodiment has at least 128 bits of ISD entropy. Some also have a non-prefix adherence signature, and other data encode in 28 or 30 additional characters.

With further attention to character sets, some embodiments support expression of a key in a manner where it will never be transformed (escaped). These transformations can change the length of a key and break regular expressions and other detection techniques. ‘% 3D’, for example, is used to encode the trailing equal sign in a 32-byte base64-encoded secret. If these secrets are, in fact, expressed in a URL, then a detector typically needs to author a regex that accounts for both the encoded and decoded forms. Some embodiments utilize a base62 character set (upper and lower case alpha and digits) because this is a safe character set for the majority of engineering contexts in which a key may be persisted or transmitted, e.g., one that avoids key length changes and breaking regex detection. The base62 character set is also good for space considerations, with nearly 6 bits per encoded character. However, there is flexibility in which character set is used to create a SDIDS. An implementor may choose a character set that conforms to their specific utilization in order to trade size of key for more constrained alphabet. A SDIDS that comprises only the characters 0-7 is perfectly feasible, for example, if one extends the key length by a factor of approximately six, to generate sequences that can encode sufficient entropy and provide sufficient other characteristics as taught herein. Similarly, one could construct a key alphabet that is nothing but special characters, or one which consists of non-printable characters, e.g., for a security model that solely allocates keys in memory and that solely scans byte arrays for them.

In this example, the following bits 1064 are reserved for the following purposes in the decoded bytes of the security key as a whole, i.e., the key identification data structure that includes the key and the predefined adherence signature:
0-311:312 bits of randomized data (5.954 bits of entropy per character).
312-347:36 bits, reserved by standard.
348-353:6 bits, year code of allocation, expressed as 2024—DateTime. UtcNow. Year.
354-359:6 bits, month code allocation, Date Time.UtcNow. Month
360-431:72 bits, reserved for security model platform use (e.g., Azure, GitHub)
432-455:24-bits, reserved for platform-specific resource provider (e.g., Azure Storage)
456-479:24-bits, provider fixed signature.
480-503: First 24-bits of Marvin checksum of bits 0-479.
504-511: [OPTIONAL] Final 8 bits of the Marvin checksum

In this example, the entire 512 bits are the sensitive data identification data structure (SDIDS) 210 and the identifiable sensitive data (ISD) 310 is inside bits 0-311. A security key is one example of identifiable sensitive data. In this example, the SDIDS includes literal data of a key 310 (i.e., the randomized bytes providing key uniqueness and security entropy), embedded metadata 400 about that key, and the two signatures 216, primary 874 and secondary 876.

In this example, the bits 856, 1064 reserved for the year code of allocation span a range of 64 years. An underlying assumption is that security keys will be replaced by another security mechanism in that time. If that does not occur, part or all of the preceding 36 bits can be repurposed as an updated timestamp.

Another option is to reserve another character for the day of the month, allowing for 24-hour granularity to determine key minting. Another option is to assign 4 bits for the month, and the remaining 8 bits for “years since 2024”. That gives a span of 256 years, instead of 64. Another approach is to encode the number of days from a fixed date, to get that level of granularity; 12 bits could handle the next 11 years, 18 bits could handle 700. A disadvantage of any approach in which there is not a single fixed encoding is that every consumer would then decode the key to do processing. With a fixed predetermined encoding, a tool can readily author checks for date ranges using a simple regex, e.g., to find all keys allocated between two different dates.

Some embodiments dedicate 12 bits to the timestamp data. However, some dedicate more than 12 bits to track short-lived tokens. Some dedicate additional bits to support more granular timestamps, such as ones that capture precision at the minutes level or the seconds level.

A given implementation could be more efficient in expanding timestamp window if it consumed the bits themselves more efficiently. However, the less efficient timestamp approach allows for regex search to find keys allocated within a specific range. The key is also readable to security responder tools and other devices that have built-in knowledge of the HIS v2 standard.

In some scenarios, the 64-byte HIS v2 format is provided for compatibility with HIS v1 implementors that already produce a 64-byte base64-encoded key. Providers that do not have this compatibility requirement optimally implement the standard 63-byte format described herein.

In some implementations, all reserved bits are aligned around 6-bit boundaries to allow creating or interpreting data strictly from the encoded character, if useful. The reserved bits are additionally aligned along 3-byte boundaries to allow easy interpretation from the decoded byte array, if useful. Regardless, however, the literal base64-encoded form does not contain special characters. They are effectively base62-encoded while remaining aligned to the base64 encoded character->byte relationship (4 characters for every 3 bytes).

Some embodiments conform with the following HIS v2 Backus-Naur Form (BNF) 858 as a general platform-agnostic standard 878.

<his-v2-key> ::= <checksum-data><partial-marvin-checksum>[<final-
marvin-checksum-byte>==]
<checksum-data> ::= <random ><his-v2-sig><year><month ><platform-
reserved><provider-reserved><provider-sig>
<random > ::= <base62 >{52}
<his-v2-sig> ::= “JQQJ9’<platform-id>
<platform-id> ::= ‘9’ | ‘D’ | ‘H’ ; ‘9’ == reserved, ‘D’ == derived key,
‘H’ = hashed using non-HIS v2 secret
<year > ::= <base62 > ; ‘A’ == 2024, ‘B’ == 2025, etc., through
maximum year code of ‘9’ (2085)
<month > ::= A-L ; “A” == January, “B” == February, etc.
<platform-reserved> ::= <base62 >{12}
<provider-reserved> ::= <base62 >{4}
<provider-sig> ::= <user-managed-key-signature> | <provider-managed-
key-signature> | <test-signature>
<user-managed-key-signature > ::= <alpha-upper>{1}<upper-and-
digits>{3} ; Except for ‘TEST’, a reserved value
<provider-managed-key-signature> ::= <alpha-lower>{1}<lower-and-
digits>{3}; Except for ‘test’, a reserved value
<test-signature> ::= ‘TEST’ | ‘test’
<partial-marvin-checksum> ::= <base62 >{4} ; First three bytes of a
Marvin32 checksum
<final-marvin-checksum-byte> ::= <base62 >{2} ; Final encoded byte of
a Marvin32 checksum
<base62> ::= <alpha-upper><alpha-lower><digits>
<upper-and-digits> ::= <alpha-upper><digits>
<lower-and-digits> ::= <alpha-lower><digits>

Although this example presents a specific predetermined adherence signature of “JQQJ99”, other embodiments utilize a different predetermined adherence signature. This particular adherence signature was selected based on frequency statistics and validated in part by grepping (searching) a large body of engineering artifacts for “JQQJ” and other sequences. Appending “99” as reserved bits improved on the rarity further.

Moreover, some embodiments differ in whether an issuer identification is part of an SDIDS, or in particular is part of an adherence signature. In some embodiments, for example, a value in the position occupied by the first ‘9’ of the example “JQQJ99” identifies an issuer, e.g., a particular vendor such as Microsoft, GitHub, etc. This preserves the initial four characters (e.g., “JQQJ”) for efficient location of any compliant key in a single detection. By adding another character, any scanner could filter on all keys issued by some broad-stroke platform/company, etc., that is prominent in their development stack. A change in the issuer id may be viewed as implementing a namespace for all the remaining metadata, in that it allows for collisions or other duplication between issuers (who are not able to easily coordinate their use of the format). Two different issuers, for example, could propose to use the exact same term as a per-provider signature (in the secondary data) and there would be no problem differentiating these keys. A corresponding BNF variation follows:

<his-v2-sig> ::= ‘JQQJ’<issuer-id><key-kind>
<issuer-id> ::= ‘9’; ‘9’ is reserved for all Microsoft keys.
<key-kind> ::= ‘9’ | ‘D’ | ‘H’; ‘9’ == primary key, ‘D’ == derived key,
‘H’ == hash of arbitrary data

Some embodiments conform with a cloud-specific HIS v2 platform reserved bits BNF, such as one suitable for Azure® clouds (mark of Microsoft Corporation). One suitable cloud-specific HIS v2 platform reserved bits BNF is shown below:

<azure-platform-reserved> ::= <unused><cloud-id><region-
id><tenant-id>
<unused> ::= ‘A’
<cloud-id> ::= <base62>{1}
<region-id> ::= <base62>{5}
<region-id> ::= <base62>{5}

For some use cases, the cloud-id and region-id metadata 400 are such that the class of key is self-consistent for a scenario, e.g., all resources in an Azure® Key Vault instance are allocated only for a single cloud+tenant, or alternately any key the consumers are able to precompute has predefined values to drive telemetry and other operations. In some situations, producing a comprehensive, normalized list of cloud regions that also remains up-to-date over time isn't practical 866.

For regions, some implementations allow an arbitrary region string literal to be passed in as metadata 400. This flexibility acknowledges that different resource providers sometimes have different literals for the region data, but these literals tend to be stable and managed reliably within a given resource provider itself.

In some implementations, a cloud identifier 808, 400 is an encoded value of ‘A’ through an upper-bound of ‘0’, reflecting a decoded value of 0-61.

In some implementations, a region identifier 808, 400 is an encoding 516 (hash) of a region string identifier. Given the relatively small number of regions for any particular cloud service provider, and the stability of the mapping of those strings (e.g., as 5-character hashes), a security review prudently assumes reversibility of the region hash. However, this region identification information has little apparent use in achieving exploitation. Rather, it is used to enforce resource hygiene or key hygiene. The hygiene 220 does not necessarily depend on readability: a consumer of this data could enforce self-consistency in keys, e.g., enforce that the region data for all keys is consistent for some scenario, no matter how that data is expressed. Key consumers could also precompute well-known region strings into an alternate representation (expressed in keys) to realize value.

In some embodiments, a cloud HIS v2 key minting API 122 will therefore accept an arbitrary string representation of a cloud region and perform the following operation on it:
Generate a SHA256 hash of the region string (a non-reversible operation).
Base62-encode the resulting hash.
Obtain the first 5 encoded character of the result and inject this sequence into characters 62-66 of the generated secret.

The technique described above allows for a small chance of collision (1 in 62\hat{ }5 or 916,132,832) between any two regions. Assuming the existence of 1000 unique regions, applying the birthday paradox formula (1−math.exp (−1000*(1000-1)/(2*(62\hat{ }5)))) yields a 0.054% chance of matching hashes.

As an example, the region string value “westus” hashes to a SHA256 value of ‘13A8A859C05EF19B4AA8E7798E5A733B39D5178BA51BB9CE44A9BDA4339 639FA’. This byte array is encoded in Base62 as “4f1cMO2UtlrUEup6fOTbbMMrhHmPaGyyhcFTv30ID3a”. The first five encoded characters of this pattern (‘4f1cM’) will be encoded in characters 62-64 of the key identification data structure.

In some embodiments, bits are reserved for a tenant identifier 808, 400, 506, 608, or a tenant class identifier 808, 400, 510, 610, or both. The tenant class is a set of tenants, or a type of tenant that is matched by one or more tenants, or both. The bits reserved in HIS v2 for the tenant information are sufficient to directly encode enough of an Azure® tenant GUID sufficient to guarantee reasonable uniqueness (62\hat{ }5). A tenant ID, however, may be useful to building an attack for a malicious actor who has obtained a loose security key.

In some clouds, there are high privilege tenants and low privilege tenants across a given division. Some embodiments tag groups of tenants based on boundaries that secrets cannot properly cross. This is enforced by secret stores upon import so that a leaking secret cannot be used across these boundaries.

The byte array of an endian-dependent GUID is not reliably hashed to a deterministic string value for platforms that differ by endianness. To generate the HIS v2 tenant key segment, therefore, some embodiments follow the technique for hashing string values described for the region identifier.

To generate a string value for hashing, the tenant GUID is converted to the lowercase string form, formatted as in this example ‘782ef2bb-3056-4438-946d-395022a4a19f’.

One would expect tenant IDs to be much more numerous than regions. As a result of the birthday paradox, given 100K unique tenant ids, the chances of at least two hashes matching is 99.736%. Because this data will encode the tenant ID of the allocating environment, however (and not the tenant id associated with an allocated resource), one can expect to observe and encode a smaller number of GUIDs. The number of sensitive and well-known tenant ids that will be used to drive security features from this data is even smaller (as few as the number of regions, or fewer). Finally, no tenant id is shared across cloud instances, so these two components (cloud code+tenant hash fragment) can be used in concert as a more fully qualified identifier that will lower chances of tenant id hash fragment collision.

As an example, a lower-case, default string expression of a Microsoft tenant id is formatted as “72f988bf-86f1-41af-91ab-2d7cd011db47”. This literal hashes to the hex-encoded SHA256 ‘2AE8F8066BAAB9E36C122F5EB5425F33AB2F5FFBEA767EA5A7D9F82DE68 OFAEC’. This byte array is encoded in Base62 as “AArohrE5dzW9SbNEsetbyqBN7 JyMoVzg3XgsA971eZA”. The first five encoded characters of this pattern (‘AAroh’) will be encoded in characters 62-66 of the key identification data structure. This is 3 characters, but the encoding will take the 5 characters from the base52 encoded hashed tenant.

With regard to documentation, emulation, and test keys, in some scenarios it is helpful to obtain and make apparent use of security keys that aren't, in fact, functional. Some examples involve emulators, unit-tests, end-to-end testing of security scanners, and customer testing of security products in advance of purchase.

To help with these scenarios, HIS v2 defines a specific and comprehensive approach for creating test keys conformant to the HIS v2 standard that are non-functional as actual keys. The ‘TEST’ and ‘test’ fixed secondary signatures are reserved for test purposes and specify keys for an entirely fictional cloud resource provider. HIS v2 also reserves 62 test keys for any specific HIS v2 allocation request 850, namely, an encoded key where every non-reserved encoded character is the same base62 alphanumeric character. Each key is created and can be validated as strictly conforming to the HIS v2 standard, including the checksum.

Because generating all combinations of a specific common character, signature, checksum seed and reserved bytes can't be guaranteed not to generate an illegal special character in the checksum, not every base62 character can be used to create a valid test key. In the following test keys, for example, the configuration did not permit a key to be constructed with the common shared characters ‘l’ (while ‘j’, ‘k’, and ‘m’ resulted in a conformant key).

jjjjjjjjjjjjjjjjjjjjjjjjjjjjjjjjjjjjjjjjjjjjjjjjj
jjjJQQJ99ADAAAAAAAAAAAAAAAAAZFRPDP5kkkkkkkkkkkkkk
kkkkkkkkkkkkkkkkkkkkkkkkkkkkkkkkkkkkkkJQQJ99ADAAA
AAAAAAAAAAAAAAZFRO6E5mmmmmmmmmmmmmmmmmmmmmmmmmmmm
mmmmmmmmmmmmmmmmmmmmmmmmJQQJ99ADAAAAAAAAAAAAAAAAA
ZFR2ICW

As an example, the following test was generated using the following configuring data: a fixed signature of ‘TEST’ denoting a test key; the ‘Preproduction’ cloud instance; the ‘westus’ region; and the Microsoft public tenant guid.

5EPCLjuETPunX3AJacdCPuo1HD4HVdPHd45yGt7LePkMq6WdP
1Y3JQQJ99AEAD4f1cMAArohAAAATESTerwl

The key above can be deconstructed as follows:

5EPCLjuETPunX3AJacdCPuo1HD4HVdPHd45yGt7LePkMq6WdP
1Y3:

312 bits of random data.
JQQJ99: HIS v2 standard-reserved fixed signature.
AE: A rough timestamp indicating allocation in May 2024.
AD: The ‘Preproduction’ cloud designation.
4f1 cM: The ‘westus’ region hashed, base62-encoded, and truncated to fit in 5 encoded characters.
Aaroh: The Microsoft public tenant GUID lower-case string, hashed, base62-encoded and truncated.
AAAA: Encoded provider-reserved characters (all with value ‘0’).
TEST: The reserved ‘TEST’ provider fixed signature indicating this key is not associated with an actual RP.
erwl: The first 24-bits of the Marvin checksum of the remainder of the key.

With respect to searchability, given the large volume discrete files, blobs, or other resources that will be scanned for secrets, it would be optimal to be able to filter out entire files in need of scanning in a performant way. Since regexs are less performant than simple IndexOf in many contexts, scanners sometimes look for a fixed predictable string (i.e., sniff literal) in the file before applying any regex to the file.

One possible string considered as a signature was 9999. However, that string is commonly occurring across many documents, e.g., source code, financial data, technical documentation, and other datasets. Accordingly, embodiments replace 9999 with a value 216 much more likely to be unique based on the frequency of letters or frequency of sequences that appear in commonly scanned data 134. Scan targets 134 in some scenarios include both source code and natural language prose (e.g., emails, comments, word processor documents).

One alphabetic sequence that uses the least frequently appearing characters in English text is ‘JQQJ’. This pattern consisting of the 26th and 25th least used letters occurs very rarely in scanned source code 862 sampling. As an example of frequency rarity validation, shown below is a set of sequences with the count of the sequence's occurrence in SourceCode Blobs and Azure® DevOps Workltem/PR Comments, and corresponding queries:

JQXZ: 13
JjJj: 63
JQQJ: 76
QJJQ: 480
ZzZz: 817
JJJJ: 5122
9999: 2540280
Query:
cluster(‘https://sourcecode.windows.net/’).database(‘SourceCode ’).Blob
| union cluster(‘https://sourcecode.windows.net/’).database(‘SourceCode
’).Blob_GitHub_OwnedPublic
| union cluster(‘https://sourcecode.windows.net/’).database(‘SourceCode
’).Blob_GitHub_ContributedPublic
| union
cluster(‘https://sourcecode.windows.net/’).database(‘VersionControlManager’).Pul
lRequestThreadComment
| union
cluster(‘https://sourcecode.windows.net/’).database(‘VersionControlManager’).Co
deReviewThreadComment
| summarize
_9999=countif(Content has_cs ‘9999’),
_JQXZ=countif(Content has_cs ‘JQXZ’),
_JJJJ=countif(Content has_cs ‘JJJJ’),
_JjJj=countif(Content has_cs ‘JjJj’),
_ZzZz=countif(Content has_cs ‘ZzZz’),
_JQQJ=countif(Content has_cs ‘JQQJ’),
_QJJQ=countif(Content has_cs ‘QJJQ’);

In some embodiments, the presence of bits reserved in the format can be used to provide extremely accurate and generic searches for keys that are allocated in the HIS v2 standard.

This regex 214 finds every HIS v2-conformant key, with an extremely high degree of accuracy. The false positive rate is 1 in 56 billion (62\hat{ }6) in the regex match only. On applying the checksum, the odds of a false positive are 1 in 839 quadrillion (62\hat{ }10).

[A-Za-z0-9]{52}JQQJ99[A-Za-z0-9][A-L][A-Za-z0-
9]{16}[A-Za-z][A-Za-z0-9]{7}([A-Za-z0-9]{2}==)?

As an example, below is a regex to find every Azure Search key, whether managed by the service or customers, allocated in June 2026:

[A-Za-z0-9]{52}JQQJ99CF[A-Za-z0-9]{16}AzSe
[A-Za-z0-9]{4}

In some embodiments, an API uses a version stamp, which is an illustrative purpose of a checksum seed. In other words, the checksum itself can denote a specific standard 878 is in use for encoding all the remaining metadata in the SDID (as well as validate the integrity of the other data).

In some embodiments, the SDIDS excludes a checksum. That is, there is no checksum 418 in the SDIDS, and the presence of a purported checksum is either ignored by metadata 400 extraction tools or treated as an error by such tools.

In some embodiments, the SDIDS includes a checksum. In some, the SDID checksum contains all 32 bits. In some cases, the checksum is a CRC32 (cyclic redundancy code) checksum. In other cases, the checksum is seeded. The preliminary seed 844, when changed, creates a new domain 846 of checksums.

Some embodiments use one or more transformations of a service provider signature to signal where a key was minted for a user (e.g., a customer) to manage as opposed to the key being managed entirely by the service provider or back-end systems. This distinction aids in determining key ownership and response routing. If a key is user-managed, some embodiments perform a resource look-up to find the allocating party. For a service-owned secret, the service itself handles the response.

In some scenarios, this distinction also determines a level of visibility that a key detecting component provides. If an embodiment detects a service-owned secret in a public repository, for example, the embodiment does not report that exposure to the repository owner but instead sends the notification of that public exposure directory to the service provider that minted the secret. The public repository owner is often a service provider agent that inadvertently exposed sensitive service provider data, but it could also be a bad actor that exposed the secret, in which case the embodiment avoids informing that party that the service provider knows the key exists there.

Some embodiments produce telemetry that corresponds to the allocation, usage, or detection of identifiable keys. Some package the constituent elements such as metadata around a key allocation, e.g., a readable representation of ‘TestKey’ to denote that state, a readable time of allocation, etc., into a message or other piece of telemetry that is put into various channels. Some embodiments provide or utilize an API to automatically generate this telemetry directly from an identifiable key. In some embodiments, a secure, non-reversible hashed representation of the key itself is included in telemetry, in place of the plaintext secret itself. This data can subsequently be consumed to understand the location, and aid the timing of a range of secret-relevant circumstances (e.g., a key X was used to log into the server, key X was invalidated preparatory to rotation, key X was freshly minted, or key X was detected in a build log and should be regarded as compromised).

Having obtained a key candidate, some embodiments also apply other useful conformance criteria.

Some embodiments ensure that all characters forming the key candidate are alphanumeric. This condition minimizes changes to the key when it is escaped for transmitting in an extended markup language (XML), hypertext markup language (HTML), encoded for expression in a URL, or encoded for another format. When special characters are escaped, a scan engine requires additional regexes and other computation to detect that variance. Some embodiments provide detectability with a single, effective regex or other detection mechanism.

Some embodiments permit an additional sequence of characters to be added to the key candidate, to allow the key to satisfy the form of an existing key format (such as a 64-byte base64-encoded value). This is a backwards compatibility feature. Some SDIDS generators are designed to be slotted into software that generates security keys today with minimal disruption. They avoid disruptions to a security key such as changes in length and changes in the alphabet forming the key.

In some embodiments, general adherence to a standard 878 includes a textual sequence ‘JQQJ’ that is empirically observed to be extremely rare as a contiguous sequence in byte arrays and textual data. As a result, some embodiments implement extremely high performance streaming scanners 214 that look for this sequence in data, using low-level hardware intrinsics and other high performance comparisons. Once observed, a more computationally intensive scanner 214 examines the surrounding data for conformance to a secrets standard 878. The rarity of the ‘JQQJ’ sequence preserves the overall throughput of detection (in one implementation, at 280 MB data/second in benchmarks).

In some embodiments, the use of an adherence signature furthermore permits an additional classification of sets of minted keys. Absent additional qualifying data, a minted key includes a primary a.k.a. root key (a loose security key that itself may be used to derive other secrets). A derived key consumes a root key as a secret (which is used, for example to initialize a cryptographic hashing algorithm) to sign arbitrary data, stuffs that signed data into the key storage area that comprises entirely randomized data in a primary key, and is otherwise annotated with metadata 400 to form an identifiable secret. In one implementation, the presence of ‘D’ in the adherence signature denotes a derived key. One implementation also defines a designation for an identifiable ‘hash’, which is a designation that a secret was used to hash some arbitrary data, the hash of which is stored in the component of the key that otherwise would hold randomized data.

In some embodiments, a minted security key signature includes useful data related to the allocation environment or runtime environment, or both, of the security asset associated with the security key. These are also referred to as a logical organizing identifier 400, 808. Some examples of data suitable as an organizing id include or identify: a specific data center associated with the resource corresponding to the key, a specific service region associated with that resource, a specific cloud instance in which the resource is allocated, a specific tenant or other logical organizing identifier in which the resource is allocated (these are typically customer-owned constructs, but Microsoft also has tenants that may aggregate cross-customer data, which are referred to as HOBO or ‘hosted on behalf of’ tenants).

In some embodiments, metadata 400 includes a subscription id or other billing-related information. A billing id helps organize resources, due to primary business motivation to organize revenue.

Some embodiments also define useful logical groupings of discrete instances of any of the above. For example, some define an organizing id 502 as including a government cloud instance, where multiple discrete cloud ids constitute a government cloud status or instance.

Some embodiments define a provider signature (secondary 876 signature 216) which denotes a specific security generator, for example, the Azure storage team. One standard 878 specifies a convention to indicate whether the provider minted keys are intended to be managed by a customer (indicated by an all upper-case form, e.g., ‘AZST’) or are minted exclusively for a back-end or service purpose (indicated by an all lower-case form). In some scenarios, other variance in casing indicates other key designations.

In some scenarios, a distinction of customer-managed vs. service managed is important in a detection response or an incident response, e.g., a customer is required to rotate and redeploy any exposed keys of this kind. A scanner that detects a service-relevant key does not inform any part about this exposure other than the service provider, since it is the back-end infrastructure that is at risk and which must be patched or updated or investigated for abuse, etc.

With further attention to Test keys, some standards 878 usefully specify a format for keys that are dedicated to test purposes. Such keys strictly conform to the standard, in that they will pass validation for checks against key length, character set, the presence of the adherence signature, etc.

Some embodiments define two classes of test key. A first class of test keys reserves an entire set of keys that that have a fictional provider, denoted by ‘TEST’ (for fictional customer-managed keys) and by ‘test’ (for fictional service managed keys). By the simple convention of reserving this provider signature, some embodiments permit the full range of other data to be completely expressed and explored for test purposes. Because there is no literal service in play for these keys, their exposure holds little if any risk. They could, for example, be included in documentation, samples, etc.

A second class of test keys reserves a range of predefined keys per-provider that are dedicated to test purposes. These keys are reserved by specifying byte ranges for the randomized data component that encoded to a pattern that is mathematically infeasible to occur as the result of an actual random number generator. And so, an identifiable key which includes a complete sequence of lower case ‘a’ characters (in the randomized data component) constitutes a test key. This data is very unlikely to be generated randomly, even if trillions of years of time are spent randomly producing keys.

Some embodiments reuse reserved bits in the key format to specify useful test behaviors for systems that process test keys. For example, in some a specific encoded character is reserved to indicate that a test system should perform test actions, including: hanging the system, introducing a specified time delay in system operation, raising an unhandled exception, introducing a delay, soliciting some other processing action by requesting that data from a server, or initiating a protective action such as a redaction, a hard-block, etc.

In general, a checksum is a small block of data that's derived from a larger block, typically to ensure the integrity of the transmission of the larger block. In the case of annotated security keys, a checksum serves a different purpose; it is used to decrease the likelihood of a false positive. That is, an implementation assumes that the remainder of the key is correct, hashes that data, and compares it to the checksum (which is typically appended to the end of a complete security key as a suffix). If the checksum matches what's expressed in the key, the implementation assumes that it does, in fact, have a key. This technique decreases the odds of a false positive in proportion to the size of the checksum itself (with some qualifications around the diffusion of the checksum algorithm). So, if one has a 32-bit checksum, the odds that this value is correct for some randomly generated data (that isn't, in fact, a generated key) is about one in four billion.

In some approaches, a fixed (prefixed) signature and an appended (CRC32) checksum is used for generated security keys. A problem with a fixed signature in some cases is that there's no relationship to this data and any other data generator in the computing domain. There is nothing that guarantees the current or permanent uniqueness of a prefix that a company chooses. In a very bad break, some other data producer could start emitting it, leading to false positives in detection. The appended checksum is an accuracy backstop, enabling post-processing to validate that the finding is truly a specific class of generated key.

Due to the purpose the checksum is applied to, many implementations use an algorithm that is chosen for computational efficiency, rather than a more computationally expensive checksum or hashing algorithm such as SHA256 (secure hash algorithm) that is often used for cryptographic purposes.

By contrast, some embodiments don't depend on a checksum to improve accuracy, but rely instead on the rarity of the adherence signature.

In some embodiments, a checksum algorithm uses an arbitrary initialization value (or seed) 844 which leads to an entirely new domain of checksums (for the same input) for every value. Some use a Microsoft Marvin algorithm which supports this feature. The seed allows embodiments to implicitly watermark or tag a generated key in arbitrary ways.

For example, assume there are two distinct classes of key to bucket. On receipt of an SDID, some embodiments first checksum the sensitive component with one seed and then the other to distinguish between the two SDID categories. This comes at the expense, of course, of reducing the value of the checksum for eliminating false positives (but as noted, this value is less important in many embodiments). The fact that this watermarking is itself not statically encoded in the key but derives from the sensitive portion of the SDID is helpful, as fixed patterns in data are easily observable by attackers.

In some embodiments, the checksum provides a unique (and entirely non-sensitive) identifier for the exposure itself. In a response, some scenarios use this checksum to communicate about a specific detection, e.g., ‘s23Jjo’ is exposed in multiple repositories.

In some embodiments, the checksum is a prefix in the SDIDS. In some, the checksum is embedded elsewhere 320 in the key.

In some embodiments, other checksums include, for example, a cryptographic checksum that's collision resistant, a keyed-hash algorithm such as hash-based message authentication code (HMAC), an algorithm that is not invertible (in which the original seed can't be reconstructed), a checksum that's larger than 32 bits (this criterion relates in part to the previous), etc.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers. Some embodiments address technical activities such as encoding, hashing, encryption or decryption, embedding, sending and receiving data over a computer network, and storing data in particular positions in a computing system memory, which are each an activity deeply rooted in computing technology. Some of the technical mechanisms discussed include, e.g., SDIDS software 302, SDIDS 210 data structures, security formats 804, repositories 836, key vaults 838, signatures 216, scanners 214, and interfaces 324. Some of the technical effects discussed include, e.g., improved identifiability of security keys, improved governance of sensitive data in a computing system, and various technical benefits called out herein. Thus, purely mental processes and activities limited to pen-and-paper are clearly excluded from the scope of any embodiment. Other advantages based on the technical characteristics of the teachings will also be apparent to one of skill from the description provided.

One of skill understands that sensitive data detection is a technical activity which cannot be performed mentally except with human-perceptible copies (which are a very small fraction of the data in any computing system, e.g., less than 1% in many cases) and at human speeds (which are insufficient for commercial scenarios and insufficient for most academic scenarios as well). Sensitive data detection cannot be performed manually with the speed and accuracy required in computing systems. Hence, security improvements such as the various examples of SDIDS functionality 204 described herein are improvements to computing technology. One of skill understands that attempting to manually detect identifiable secrets data structures would create unacceptable delays in software operation, and introduce unnecessary and unacceptable human errors and security risks. People manifestly lack the speed, accuracy, memory capacity, and specific processing capabilities required to perform SDIDS security enhancements taught herein.

Different embodiments provide different technical benefits or other advantages in different circumstances, but one of skill informed by the teachings herein will acknowledge that particular technical advantages will likely follow from particular embodiment features or feature combinations, as noted at various points herein. Any generic or abstract aspects are integrated into a practical 866 application such as sensitive data detectors in cloud functionality providers. Some implementations are utilized across some aspects of Azure® clouds, to provide for efficient security responses and to enable security features for Azure® DevOps and Azure® customers, e.g., some adopters include Azure Entra™, Azure® DevOps, Azure® Maps, and Azure® OpenAI™ (from the general cognitive services uptake of the standard) (marks of Microsoft Corporation and OpenAI, Inc., respectively).

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not.

Rather, the present disclosure is focused on providing appropriately specific embodiments whose technical effects fully or partially solve particular technical problems, such as how to improve detectability of leaked security keys, how to improve detection of expired security keys, how to test security mechanisms without risking exposure of sensitive data, and how to determine whether copies of a security key have a shared ancestor. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, language models, prompts, motivating examples, operating environments, tools, peripherals, software process flows, identifiers, repositories, data structures, data selections, naming conventions, notations, control flows, or other implementation choices described herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CLI: command line interface, command line interpreter
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
IDE: integrated development environment
LAN: local area network
OS: operating system
PaaS or PAAS: platform-as-a-service
RAM: random access memory
ROM: read only memory
SIEM: security information and event management
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin (x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or a user session or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a technical term in the computing science arts (a kind of “routine”) but it is also a patent law term of art (akin to a “method”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. SDIDS operations such as scanning 1010, extracting 1004, and embedding 1002, and many other operations discussed herein (whether recited expressly in the Figures or not), are understood to be inherently digital and computational. A human mind cannot interface directly with a CPU or other processor, or with RAM or other digital storage, to read and write the necessary data to perform the SDIDS steps 1000 taught herein even in a hypothetical situation or a prototype situation, much less in an embodiment's real world large computing environment, e.g., an internet-connected environment. This would all be well understood by persons of skill in the art in view of the present disclosure. Moreover, one of skill understands that SDIDS functionality cannot be implemented merely with conventional tools and steps, because actual implementation requires the use of teachings which were first provided in the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as alerting, anonymizing, blocking, correlating, dedicating, deleting, deriving, embedding, encoding, extracting, filtering, forming, generating, hanging, hashing, improving, invalidating, locating, logging, masking, mitigating, obfuscating, outperforming, performing, placing, propagating, raising, scanning, selecting, utilizing (and alerts, alerted, anonymizes, anonymized, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest. Example verbs listed here may overlap in meaning or even be synonyms; separate verb names do not dictate separate functionality in every case.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

Some terms are hyphenated herein, but alternate hyphenations or non-hyphenated versions will be understood by one of skill to refer to the same thing.

### REMARKS REGARDING REFERENCE NUMERALS

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, security controls; hardware tools; computational
126 display screens, also referred to as “displays”
128 computing hardware not otherwise associated with a reference numeral 106, 108, 110, 112, 114
130 sensitive data, e.g., data which is marked or labeled as sensitive, or data whose content meets an applicable policy or an applicable regulation definition of sensitive, where sensitive indicates heightened confidentiality, heightened privacy, heightened mission criticality, a heightened availability requirement, or a heightened integrity (tamper avoidance, corruption avoidance) requirement
132 metadata, e.g., data 118 about other data 118
136 cloud, also referred to as cloud environment or cloud computing environment
202 enhanced computing system, i.e., system 102 enhanced with functionality 204 as taught herein
204 SDIDS functionality (also referred to as functionality 204, or enhancement 204), e.g., software or specialized hardware which performs or is configured to perform step 304, or steps 306, 308, and 312, or steps 306 and 1004, or steps 304 and 1002, or any software or hardware which performs or is configured to perform an SDIDS security enhancement activity first disclosed herein, or to perform a novel method 1000 first disclosed herein
808 identifier generally; digital
900 flowchart; 900 also refers to SDIDS methods that are illustrated by or consistent with the FIG. 9 flowchart or any variation of the FIG. 9 flowchart described herein; all SDIDS method steps are computational, not human activity
1000 flowchart; 1000 also refers to SDIDS methods that are illustrated by or consistent with the FIG. 10 flowchart, which incorporates the FIG. 9 flowchart, the steps in FIGS. 2, 3, and 8, and all other steps taught herein, or methods that are illustrated by or consistent with any variation of the FIG. 10 flowchart described herein; all SDIDS method steps are computational, not human activity
1070 any step or item discussed in the present disclosure that has not been assigned some other reference numeral; 1070 may thus be shown expressly as a reference numeral for various steps or items or both, and may be added as a reference numeral (in the current disclosure or any subsequent patent application which claims priority to the current disclosure) for various steps or items or both without thereby adding new matter

### CONCLUSION

Some embodiments provide or utilize SDIDS functionality 204 which increases the security of computer operations. Some embodiments form 304 a contiguous sensitive data identification data structure (SDIDS) 210 which includes an identifiable sensitive data (ISD) 310 portion. Some embodiments scan 1010 for an SDIDS, and some do both. The SDIDS is distinguished by at least one of: specified rarity 316 or 318 of an adherence signature 216, absence of a checksum 418, primary and secondary adherence signatures in a hierarchy 314, non-prefix adherence signature position 320 placement 1056, non-suffix checksum position 320 placement 1058, or particular kinds of metadata 400 in the SDIDS 210. Some examples of suitable metadata 400 include timestamp metadata 402, deployment metadata 404, origination metadata 406, ownership metadata 414, metadata 408, 410 for testing, correlation metadata 412, and combinations thereof. Some ISD examples include security keys 208, tokens, passwords, pass phrases, cryptologic artifacts, confidential data, private data, critical data, and data that is tagged or labeled as sensitive.

Embodiments are understood to also themselves include or benefit from tested and appropriate security controls and privacy controls such as the General Data Protection Regulation (GDPR). Use of the tools and techniques taught herein can be used together with such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A cybersecurity method which is performed by a computing system, the computer system having a hardware memory in operable communication with a hardware processor, the computer system having scanning access to a corpus of digital documents which has a predefined scope, the method comprising the computing system:
forming a contiguous sensitive data identification data structure (SDIDS) in the hardware memory, the SDIDS comprising at least one of: (a) a predefined primary adherence signature plus a predefined secondary adherence signature in a hierarchy whereby the predefined secondary adherence signature is selected from a plurality of predefined secondary adherence signatures which are each associated with a respective nonempty proper subset of a nonempty set of SDIDS instances, each SDIDS instance having the predefined primary adherence signature, (b) the predefined primary adherence signature having an instance frequency within the corpus of digital documents that is no greater than one in ten billion, or (c) the predefined primary adherence signature being internal to the SDIDS and hence not being a prefix of the SDIDS;
ascertaining an identifiable sensitive data (ISD) within the SDIDS; and
utilizing the SDIDS to improve security functioning of the computing system.

2. The method of claim 1, comprising at least one of: embedding timestamp metadata in the SDIDS, or extracting embedded timestamp metadata from the SDIDS.

3. The method of claim 1, comprising at least one of: embedding deployment metadata in the SDIDS, or extracting embedded deployment metadata from the SDIDS, wherein the deployment metadata represents at least one of: an authorized deployment cloud status of public, an authorized deployment cloud status of private, an authorized deployment cloud status of governmental, an authorized deployment cloud region identifier, an authorized deployment cloud tenant identifier, an authorized deployment cloud tenant class identifier, an authorized deployment data center identifier, an authorized deployment cloud account identifier, an authorized deployment cloud status of development test environment, an authorized deployment cloud status of preproduction environment, or an authorized sensitive data manager identifier.

4. The method of claim 1, comprising at least one of: embedding origination metadata in the SDIDS, or extracting embedded origination metadata from the SDIDS, wherein the origination metadata represents at least one of: a minting service identifier, a minting provider identifier, a minting cloud region identifier, a minting cloud tenant identifier, a minting cloud tenant class identifier, a minting data center identifier, or a minting cloud account identifier.

5. The method of claim 1, comprising at least one of: embedding test metadata in the SDIDS, or extracting embedded test metadata from the SDIDS, the test metadata indicating at least one of: the ISD is a test ISD whose unauthorized exposure is an acceptable risk event during testing of the security functioning of the computing system, the ISD is a test ISD whose unauthorized exposure is an expected event during testing of the security functioning of the computing system, or the SDIDS is a testing artifact having a fictional provider.

6. The method of claim 1, wherein utilizing the SDIDS to improve security functioning of the computing system comprises embedding a padded copy of the SDIDS in a document in conformance with a security format which dedicates more bits to identification of sensitive data than are dedicated in the SDIDS.

7. The method of claim 1, wherein utilizing the SDIDS to improve security functioning of the computing system comprises utilizing a correlation identifier of the SDIDS by correlating the ISD across at least two of: a runtime deployment environment, a secrets store, a resource administration portal, or a sensitive data detection tool.

8. The method of claim 1, wherein the ISD comprises a security key, and utilizing the SDIDS to improve security functioning of the computing system comprises utilizing a correlation identifier of the SDIDS by correlating the ISD across at least three of: a runtime deployment environment, a secrets store, a resource administration portal, a sensitive data detection tool, or a key detection tool.

9. The method of claim 1, wherein utilizing the SDIDS to improve security functioning of the computing system comprises scanning for an instance of the SDIDS in at least one of: a data stream, a network communication, a nonempty set of disk files, a memory at runtime, a crash dump, a software repository communication upload, a cloud key vault, a nonempty set of digital documents, or a nonempty set of binary data.

10. A cybersecurity method which is performed by a computing system, the computer system having a hardware memory in operable communication with a hardware processor, the computer system having scanning access to a corpus of digital documents which has a predefined scope, the method comprising the computing system:
locating a contiguous sensitive data identification data structure (SDIDS) in the hardware memory at least in part by scanning, the scanning having a false positive frequency within the corpus of digital documents that is no greater than one in twenty billion, the SDIDS comprising at least one of: (a) a predefined primary adherence signature plus a predefined secondary adherence signature in a hierarchy whereby the predefined secondary adherence signature is selected from a plurality of predefined secondary adherence signatures which are each associated with a respective nonempty proper subset of a nonempty set of SDIDS instances, each SDIDS instance having the predefined primary adherence signature, (b) the predefined primary adherence signature having an instance frequency within the corpus of digital documents that is no greater than one in one billion, or (c) the predefined primary adherence signature being internal to the SDIDS and hence not being a prefix of the SDIDS;
ascertaining an identifiable sensitive data (ISD) within the SDIDS; and
utilizing the SDIDS to improve security functioning of the computing system.

11. The method of claim 10, wherein the scanning scans for an instance of the SDIDS at a speed of at least 100000 bytes per second.

12. The method of claim 10, wherein utilizing the SDIDS to improve security functioning of the computing system comprises at least one of: alerting, anonymizing, blocking, correlating, deleting, encrypting, filtering, hashing, invalidating, logging, masking, mitigating, obfuscating, pseudonymizing, or redacting.

13. The method of claim 10, wherein utilizing the SDIDS to improve security functioning of the computing system comprises at least one of: deriving a security key, deriving an SDIDS, propagating at least a portion of metadata from the SDIDS, or embedding a derivation metadata into the SDIDS.

14. The method of claim 10, comprising at least one of: embedding seeded checksum metadata in the SDIDS, or extracting embedded seeded checksum metadata from the SDIDS.

15. The method of claim 10, comprising at least one of: embedding test behavior metadata in the SDIDS, or extracting embedded test behavior metadata from the SDIDS, the test behavior metadata representing a test behavior, the test behavior comprising at least one of: hanging a system, introducing a specified time delay in system operation, raising an unhandled exception, requesting data from a server, or performing a cybersecurity protective action.

16. A computing system, the computing system having access to a corpus of digital documents which includes at least one terabyte of data, the computing system comprising:
a digital hardware memory;
a processor set including at least one hardware processor, the processor set in operable communication with the digital hardware memory; and
a cybersecurity software which upon execution by the processor set (i) forms a contiguous sensitive data identification data structure (SDIDS) in the hardware memory, the SDIDS comprising at least one of: (a) a predefined primary adherence signature plus a predefined secondary adherence signature in a hierarchy whereby the predefined secondary adherence signature is selected from a plurality of predefined secondary adherence signatures which are each associated with a respective nonempty proper subset of a nonempty set of SDIDS instances, each SDIDS instance having the predefined primary adherence signature, (b) the predefined primary adherence signature having an instance frequency within the corpus of digital documents that is no greater than one in ten billion, or (c) the predefined primary adherence signature being internal to the SDIDS and hence not being a prefix of the SDIDS, (ii) ascertains an identifiable sensitive data (ISD) within the SDIDS, and (iii) utilizes the SDIDS to improve security functioning of the computing system.

17. The computing system of claim 16, wherein the SDIDS comprises at least one of the following security enhancement items: timestamp metadata embedded in the SDIDS, deployment metadata embedded in the SDIDS, origination metadata embedded in the SDIDS, test metadata embedded in the SDIDS, test behavior metadata embedded in the SDIDS, derivation metadata embedded in the SDIDS, ownership metadata embedded in the SDIDS, or a correlation identifier embedded in the SDIDS.

18. The computing system of claim 17, wherein the SDIDS comprises at least two of the security enhancement items.

19. The computing system of claim 17, wherein the SDIDS comprises at least three of the security enhancement items.

20. The computing system of claim 17, wherein the SDIDS comprises at least four of the security enhancement items.
